(19) United States
(12) Patent Application Publication
(10) Pub. No.: US 2025/0283373 A1
(43) Pub. Date: Sep. 11, 2025

(54) PRESSURE CONTROL SYSTEMS AND TECHNIQUES FOR INSULATING GLASS UNITS

(71) Applicant: Cardinal IG Company, Eden Prairie, MN (US)

(72) Inventors: Jacob Louis Besser, Minneapolis, MN (US); Robert Charles Grommesh, Saint Louis Park, MN (US); Daniel Eliah Moreno, Brooklyn Park, MN (US); Abigail Elise Radomski, Saint Louis Park, MN (US); John Brian Shero, Savage, MN (US)

(21) Appl. No.: 19/071,569

(22) Filed: Mar. 5, 2025

Related U.S. Application Data
(60) Provisional application No. 63/562,627, filed on Mar. 7, 2024.
(60) Provisional application No. 63/650,888, filed on May 22, 2024.

(51) Int. Cl. E06B 3/677; E06B 3/663

(52) U.S. Cl. CPC E06B 3/677; E06B 3/663

(57) ABSTRACT

Insulating glass units and techniques for manufacturing insulating glass units are described. In some examples, a manufacturing technique involves filling a between-pane space located between a first glass pane and a second glass pane of an insulating glass unit with an insulative gas to ambient pressure at the location where the insulating glass unit is manufactured. The insulating glass unit can include one or more features allowing the pressure of the insulative gas to be adjusted (increased and/or decreased) after initial fabrication of the insulating glass unit. For example, the insulating glass unit can include one or more features allowing the pressure of the insulating gas to be adjusted from ambient pressure at the location of manufacture to a different ambient pressure corresponding to an elevation where the insulating glass unit is intended to be delivered and installed in a building.

### CROSS-REFERENCE

This application claims the benefit of U.S. Provisional Patent Application No. 63/562,627, filed Mar. 7, 2024, and U.S. Provisional Patent Application No. 63/650,888, filed May 22, 2024, the entire contents of each of which are incorporated herein by reference.

### TECHNICAL FIELD

This disclosure relates to insulating glass units and, more particularly, to configurations and techniques for controlling the gas pressure in an insulating glass unit to accommodate pressure differences between the location of manufacture and the location of use for the insulating glass unit.

### BACKGROUND

Insulating glass units are generally formed from two or more parallel panes of glass which are spaced apart from each other and which have the space between the panes sealed along the peripheries of the panes to enclose a gas space between them. For example, a double pane window may be formed from two panes of glass, often rectangular in shape, which are placed in congruent relationship. A spacer is typically positioned around and between the peripheral edges of the two panes of glass so as to seal a gas space between the two panes of glass. Depending on the construction of the insulating gas unit, the gas space may be filled with insulating gas such as dry air, argon, krypton, or the like.

Because insulating gas units have a sealed gas space, the structure of the insulating glass unit may be impacted by changes in the ambient pressure surrounding the insulating glass unit. For example, when an insulating glass unit is filled with an insulating gas at a location of manufacture, the gas sealed inside the insulating glass unit is often at the same pressure as the surrounding atmosphere. If, however, the insulating glass unit is subsequently shipped from the point of manufacture to a point of use that is at a substantially different elevation, the pressure inside the insulating glass unit may vary meaningfully from the ambient pressure at the point of use. For instance, if an insulating glass unit is manufactured around sea level to contain an ambient pressure sealed gas and then transported to a high elevation point of use, the ambient pressure at the point of use may be meaningfully lower than the pressure of the gas sealed inside the insulating glass unit. When this occurs, the glass panes of the insulating glass unit may bow outward, resulting in convex shaped glass panes. This can cause optical distortion associated with reflections when viewing the insulating glass unit and an undesired physical appearance for the unit. Further, pressure differences can create tensile stress on the peripheral seal of the insulating glass unit and bending force on the glass, potentially weakening the seal and leading to a risk of glass breakage.

### SUMMARY

In general, this disclosure is directed to insulating glass units and techniques for manufacturing insulating glass units. In some examples, a manufacturing technique involves filling a between-pane space located between a first glass pane and a second glass pane of an insulating glass unit with an insulative gas. The between-pane space of the insulating glass unit can be filled with the insulative gas to a certain pressure, such ambient pressure at the location where the insulating glass unit is being manufactured. The insulating glass unit can include one or more features allowing the pressure of the insulative gas to be adjusted (increased and/or decreased) after initial fabrication of the insulating glass unit. For example, the insulating glass unit can include one or more features allowing the pressure of the insulating gas to be adjusted from ambient pressure at the location of manufacture to a different ambient pressure corresponding to an elevation where the insulating glass unit is intended to be delivered and installed in a building.

In some examples, an insulating glass unit is configured with a spacer key carrying a septum. The spacer key is installed during assembly of the spacer, thereby installing the septum on the spacer. After assembly and gas filling of the insulating glass unit in which the spacer is positioned between opposed glass panes to hermitically seal gas in a between-pane space, the septum can be penetrated by a tubular structure. The gas pressure in the between-pane space can then be increased or decreased relative to the original gas fill pressure, e.g., to adjust the gas pressure from ambient pressure at the location of manufacture to the ambient pressure at a target elevation where the insulating glass unit is intended to be used. Thereafter, the pierced septum can be sealed with one or more sealing materials for the service life of the insulating glass unit.

In other examples, the insulating glass unit is configured with a spacer key operatively connected to a valve. The spacer key is installed during assembly of the spacer, thereby installing the valve on the spacer. Assembly and gas filling of the insulating glass unit in which the spacer is positioned between opposed glass panes to hermitically seal gas in a between-pane space places the valve in fluid communication with the between-pane space. After fabrication, the insulating glass unit can be transported from a manufacturing location to a deliver and/or use location at a different elevation and ambient pressure than the ambient pressure at the manufacturing location. The valve can automatically open in response to a pressure differential between the between-pane space and the ambient environment, e.g., allowing the between-pane space to pressure equalize with the ambient environment. In some examples, one or more sealing materials are used to seal the valve after pressure equalization for the service life of the insulating glass unit.

As a further example, the insulating glass unit may be fabricated from one or more panes having an opening extending through a face of the pane. The opening can be temporarily sealed, e.g., with a plug, tape, film, and/or other removable sealant. The insulating glass unit can be fabricated with a gas fill pressure substantially equal to the ambient pressure at the location of manufacture of the insulating glass unit. After fabrication, the insulating glass unit can be transported to a different elevation and the temporary seal can then be removed from the opening to allow the between-pane space to pressure adjust with an ambient environment. When at a suitable final pressure, the opening can be permanently sealed for the service life of the insulating glass unit.

In additional or alternative configurations, the insulating glass unit may be fabricated from one or more panes having an opening extending through a face of the pane and a valve can be operatively connected to opening. For example, the valve may be configured with a shaft and a head, and the shaft can be inserted into the opening with the head positioned adjacent to and/or in contact with the face of the pane surrounding the opening. The valve can be a one-way valve (e.g., only allowing egress of insulating gas to the surrounding environment or ingress of atmospheric air into the between-pane space) or a two-way valve. In either, the valve may can automatically open in response to a pressure differential between the between-pane space and the ambient environment based on changes in atmospheric pressure between a location of manufacture and transport and/or installation location. Once at a desired location, the valve can be disengaged from the opening (e.g., by removing the stem of the valve from the opening) and the opening permanently sealed for the service life of the insulating glass unit. In some specific implementations, the valve is temporarily held in the opening by an adhesive, such as a stretch releasing adhesive, and an operator breaks and adhesive bond between the valve and pane (e.g., by pulling a tab to stretch and release the adhesive) to remove the valve from the pane.

Independent of the specific arrangement and configuration of pressure adjusting features, the pressure adjusting features can be used to adjust the pressure in the pressure of the insulative gas after initial fabrication of the insulating glass unit, e.g., to correspond to an atmospheric pressure at a location where the insulating glass unit is to be transported, sold, installed, and/or otherwise used. Adjusting the pressure can be beneficial to help ensure that the glass panes forming the insulating glass unit remain substantially in parallel alignment with each other (e.g., without the glass panes of the insulating glass unit visually bowing outward or inward and appearing concave or convex to the unaided eye). This can maintain the aesthetic appearance of the unit (and when viewing through the unit), particularly when the unit is configured as a divided lite with muntin or grill bars inside or outside of the unit.

According to one example described herein, an insulating glazing structure includes a first pane of transparent material, a second pane of transparent material, and a spacer. According to the example, the spacer is positioned between the first pane of transparent material and the second pane of transparent material to define a between-pane space. The example further specifies that the spacer seals the between-pane space from gas exchange with a surrounding environment and holds the first pane of transparent material a separation distance from the second pane of transparent material. The example provides that the spacer includes a tubular body having a first end and a second end joined together by a key. According to the example, the key has a first key end and a second key end that are inserted into the first end and the second end of the tubular body, respectively. The example further specifies that the key includes a septum positioned between the first end and the second end of the tubular body, and the septum is pierced and sealed closed with a sealing material. According to the example, the between-pane space is filled with an insulating gas.

In another example, a method includes filling a between-pane space of an insulating glazing structure with an insulating gas to define a gas fill pressure in the between-pane space. The example provides that the between-pane space is defined between a first pane of transparent material and a second pane of transparent material. According to the example, positioning a spacer between the first pane of transparent material and a second pane of transparent material seals the between-pane space from gas exchange with a surrounding environment. The example further specifies that the spacer comprises a tubular body having a first end and a second end joined together by a key, and the key comprises a septum. The example of the method includes piercing the septum and adjusting a pressure of the insulating gas in the between-pane space through a pierce in the septum so that the pressure in the between-pane space is different than the fill pressure. According to the example, the method includes sealing the pierce through the septum with a sealing material.

In another example, a method includes transporting an insulating glazing structure from a location of manufacture to an elevation having a different atmospheric pressure than an atmospheric pressure at the location of manufacture. The example provides that the insulating glazing structure includes a first pane of transparent material, a second pane of transparent material, and a spacer positioned between the first pane of transparent material and the second pane of transparent material. In the example, the spacer defines a between-pane space. The between-pane space contains an insulative gas, and the spacer seals the between-pane space from gas exchange with a surrounding environment. According to the example, while at the elevation having the different atmospheric pressure than the atmospheric pressure at the location of manufacture, the method includes removing a temporary seal covering an opening providing access to the between-pane space and allowing a pressure of the insulative gas in the between-pane space to pressure adjust with the different atmospheric pressure. The example further specifies allowing the pressure of the insulative gas in the between-pane space to pressure adjust with the different atmospheric pressure, sealing the opening.

In another example, an insulating glazing structure includes a first pane of transparent material, a second pane of transparent material, and a spacer positioned between the first pane of transparent material and the second pane of transparent material. In the example, the spacer defines a between-pane space filled with an insulating gas and seals the between-pane space from gas exchange with a surrounding environment. The example further specifies that the spacer holds the first pane of transparent material a separation distance from the second pane of transparent material. The between-pane space is filled with an insulating gas. In the example, the spacer includes a tubular body having a first end and a second end joined together by a key. The key has a first key end and a second key end that are inserted into the first end and the second end of the tubular body, respectively. According to the example, the key includes a valve fluidly connected to the between-pane space and configured to allow selective fluid communication between the between-pane space and the surrounding environment to pressure equalize a pressure of the insulating gas in the between-pane space with an atmospheric pressure of the surrounding environment.

In another example, an insulating glazing structure is described that includes a first pane of transparent material, a second pane of transparent material, and a spacer positioned between the first pane of transparent material and the second pane of transparent material to define a between-pane space filled with an insulating gas. The spacer seals the between-pane space from gas exchange with a surrounding environment and holds the first pane of transparent material a separation distance from the second pane of transparent material. The between-pane space is filled with an insulating gas. According to the example, an opening is formed through a face of the first pane of transparent material and a valve is fluidly connected to the opening and configured to allow selective fluid communication between the between-pane space and the surrounding environment to pressure equalize a pressure of the insulating gas in the between-pane space with an atmospheric pressure of the surrounding environment.

In another example, a method is described that involves transporting an insulating glazing structure from a location of manufacture to an elevation having a different atmospheric pressure than an atmospheric pressure at the location of manufacture. The example specifies that the insulating glazing structure includes a first pane of transparent material, a second pane of transparent material, and a spacer positioned between the first pane of transparent material and the second pane of transparent material to define a between-pane space, the between-pane space containing an insulative gas, and the spacer sealing the between-pane space from gas exchange with a surrounding environment. The example method includes allowing a pressure of the insulative gas in the between-pane space to pressure adjust with the different atmospheric pressure via a valve fluidly connected to an opening providing access to the between-pane space and, after allowing the pressure of the insulative gas in the between-pane space to pressure adjust with the different atmospheric pressure, removing the valve and sealing the opening.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a perspective drawing of an example insulating glass unit.

FIG. 2 is a cross-sectional view of the example insulating glass unit of FIG. 1 taken along the A-A cross-sectional line indicated on FIG. 1.

FIG. 3 is a schematic illustration of an example configuration of a tubular spacer have opposed ends joined together by a spacer key.

FIG. 4 is a perspective drawing illustrating an insulating glass system including a pressure adjustment system.

FIG. 5 is a perspective view of an example insulating glass unit.

FIG. 6A is a perspective view of an example key of an insulating glass unit.

FIG. 6B is a top view of an example key of an insulating glass unit.

FIG. 6C is a bottom view of an example key of an insulating glass unit.

FIG. 6D is a side view of an example key of an insulating glass unit.

FIGS. 6E-6G are illustrations of an example portion of a spacer key utilizing a septum that is mounted generally flush with inner and outer surfaces of the spacer key.

FIGS. 6H-6K are illustrations of an example configuration of a spacer key in which the septum is defined by a thin wall of the same material forming the spacer key.

FIGS. 6L-6O are illustrations of another example configuration of a spacer key utilizing an overmolded septum.

FIG. 7A is a perspective view of an example septum of an insulating glass unit.

FIG. 7B is a side view of an example septum of an insulating glass unit.

FIG. 7C is a cross-sectional view of an example septum of FIG. 7B taken along the A-A cross-sectional line indicated on FIG. 7B.

FIG. 8A is a perspective view of an example septum and plug of an insulating glass unit.

FIG. 8B is a perspective view of an example septum and plug of an insulating glass unit.

FIG. 9 is a side view of an example valve in a key of an insulating glass unit.

FIG. 10 is a perspective view of an example insulating glass unit including an opening through a pane.

FIG. 11 is a perspective view of the example insulating glass unit of FIG. 10 showing a temporary seal over the opening.

FIG. 12 is a perspective view of an example plug that can be used with an insulating glass unit.

FIG. 13 is a perspective view of the example plug of FIG. 12 inserted into the opening in the insulating glass unit of FIG. 10.

FIG. 14A is a perspective view of an example valve that can be used with an insulating glass unit as described herein.

FIG. 14B is a perspective view of a portion of an insulating glass unit illustrating the example valve from FIG. 14A inserted into an opening.

FIG. 14C is a perspective view of an example configuration of a valve that includes a bushing at the end of a portion of a stem insertable into an opening.

FIG. 15 is a perspective view of an example configuration of an insulating glass unit showing an example arrangement for fluidly coupling a valve through an opening extending through a thickness of a pane of transparent material.

FIG. 16 is a perspective illustration of an example configuration of a coupling for the example configuration of FIG. 15.

### DETAILED DESCRIPTION

In general, an insulating glass unit provides an optically transparent thermally insulating structure that can be mounted in the wall of a building. In different examples, the insulating glass unit may be fabricated from two panes of material, which may be referred to as a double pane insulating glass unit, three panes of material, which may be referred to as a triple pane insulating glass unit, or even four or more panes of material. Each pane of material in the insulating glass unit may be separated from an opposing pane of material by a between-pane space, which may be filled with an insulating gas or evacuated to create a vacuum. Increasing the size and number of between-pane spaces in the insulating glass unit typically increases the thermal efficiency of the unit by reducing the thermal conductivity across the insulating glass unit. For example, when the insulating glass unit is positioned on an exterior wall of the building, a temperature differential between an interior environment on one side of the insulating glass unit and an exterior environment on another side of the insulating glass unit may create a driving force that causes thermal loss across the insulating glass unit.

During manufacture of the insulating glass unit, the insulating gas may be dispensed into the between-pane space and then sealed in the space by inserting a spacer between opposed panes of transparent material. The spacer may hold the panes of transparent material in a generally parallel and spaced-apart orientation. The spacer may also seal the between-pane space so that the gas dispensed into the space is isolated from any gas in the ambient environment surrounding the insulating gas unit.

In some applications, the insulating glass unit is fabricated at one manufacturing location and then transported to a different physical location where the insulating glass unit is sold and/or installed in a building. During this process, the insulating glass unit may be transported from a location having a certain ambient pressure to a different location having a different ambient pressure. For example, the insulating glass unit may be manufactured at a location that is at one elevation with respect to sea level and then transported to a different location that is at a higher or lower elevation with respect to sea level. A higher elevation location will have a lower ambient pressure than the ambient pressure at a lower elevation where the insulating glass unit was manufactured. If the pressure of the gas in the insulating glass unit is too high in these applications, the gas pressure may cause the panes of the insulating glass unit to bow outward, distorting the optics and/or appearance of the unit. Further, higher pressure gas inside the insulating glass unit may create stress on the peripheral seal of the insulating glass unit, reducing the service life of the seal. This may occur when the insulating glass unit is transported to the higher elevation location and there is less ambient pressure acting on the external surfaces of the panes to counteract the pressure of the gas inside the unit. Alternatively, if the insulating glass unit is transported to a lower elevation location, the pressure of the insulating gas inside of the unit may be lower than the ambient pressure, causing the panes of the insulating glass unit to bow inwardly, also distorting the optics and/or appearance of the unit and/or creating stresses on the peripheral seal of the unit.

This disclosure generally relates to insulating glass units, as well as associated systems and techniques, that can accommodate an ambient pressure differential between a location of manufacture and a location where the insulating glass unit is subsequently delivered, sold, installed, and/or used. In some examples, an insulating glass unit is constructed with a septum that can be accessed to adjust the pressure within the between-pane space of the insulating glass unit. During fabrication, a between-pane space of the insulating glass unit can be filled with an insulating gas and sealed by a spacer to define a gas fill pressure in the between-pane space. The gas fill pressure may be substantially equal to the ambient pressure at the location of manufacture of the insulating glass unit. With the insulating glass unit sealed to close the between-pane space, the manufacturer can pierce the septum to selectively access the between-pane space. For example, the manufacturer can pierce the septum with a lumen (e.g., needle) in fluid communication with the device operable to adjust the pressure inside of the between-pane space.

For example, in applications where the insulating glass unit is manufactured at a lower elevation than a target elevation to where the insulating glass unit is intended to be delivered and/or used, the manufacturer may withdraw a portion of the insulating gas from the between-pane space to lower the gas pressure inside of the insulating glass unit. The lumen penetrating the septum of the insulating glass unit may be connected to a vacuum source that is operable to withdraw a portion of the insulating gas out of the unit to reduce the gas pressure inside of the unit below ambient pressure at the location manufacture. The manufacturer may reduce the pressure in the between-pane space down to a pressure that is substantially equivalent to atmospheric pressure at a target elevation where the insulating glass unit is intended to be delivered and/or used. Accordingly, when the insulating glass unit is subsequently delivered to that target elevation (e.g., for installation in a building), the gas pressure inside of the between-pane space of the unit may be substantially equal to ambient pressure at that location. As a result, the interior of the insulating glass unit is pressure balanced with the pressure of the ambient environment, reducing or eliminating stresses in optical distortions caused by having a pressure differential between the between-pane space and ambient environment.

In other applications where the insulating glass unit is manufactured at a higher elevation than a target elevation to where the insulating glass unit is intended to be delivered and/or used, the manufacturer may introduce an additional portion of the insulating gas into the between-pane space to increase the gas pressure inside of the insulating glass unit. The lumen penetrating the septum of the insulating glass unit may be connected to a gas source that is operable to introduce an additional amount of insulating gas into the unit (above the amount introduced into the unit during initial filling and fabrication) to increase the gas pressure inside of the unit above ambient pressure at the location manufacture. The manufacturer may increase the pressure in the between-pane space to a pressure that is substantially equivalent to atmospheric pressure at a target elevation where the insulating glass unit is intended to be delivered and/or used. Accordingly, when the insulating glass unit is subsequently delivered to that target elevation (e.g., for installation in a building), the gas pressure inside of the between-pane space of the unit may be substantially equal to ambient pressure at that location. Again, this can reduce or eliminate undesirable effects associated with a pressure imbalance between the insulating glass unit in the ambient environment.

In some implementations, the septum of the insulating glass unit that facilitates pressure adjustment is provided on a spacer key that is then installed during assembly of the spacer used on the unit. For example, the spacer used to seal the between-pane space and hold adjacent panes parallel to each other may be formed as a tubular structure extending around the perimeter of the insulating glass unit. The tubular structure may contain desiccant that absorbs moisture to help keep the interior of the between-pane space dry. The tubular structure may be fabricated from a single length of material bent to form the perimeter shape of the insulating glass unit or from multiple lengths of material joined together. In either case, the tubular structure of the spacer may have first and second ends that are joined together with a spacer key to close the perimeter shape of the spacer.

In some examples according to the disclosure, the spacer key includes a first key end insertable into a first open end of the tubular spacer and a second key end insertable into a second open end of the tubular spacer. The spacer key can include an intermediate region extending between the first and second ends of the tubular spacer (e.g., when the spacer key is fully joined with the tubular spacer). The septum can be positioned in the intermediate region. Configuring the spacer key to carry a septum for installation during fabrication of the insulating glass unit can be beneficial for a variety of reasons. For manufacturing processes where a spacer key is already installed during assembly of an insulating glass unit, configuring the spacer key to carry the septum can allow the manufacturer to efficiently install the septum without requiring additional processing (e.g., drilling a hole through the spacer and installing the septum through that separate hole). Additionally or alternatively, the spacer key may be fabricated from a material having a greater wall thickness than the wall thickness of the tubular spacer. For example, the wall thickness of the spacer key may be an order of magnitude or even to orders of magnitude greater than the wall thickness the tubular spacer. As a result, the spacer key may provide better mechanical rigidity and a stronger sealing surface than if the septum were inserted directly into the spacer.

Independent of the configuration and location of the septum, a user may seal the septum after adjusting the pressure of the between-pane space through the septum. In some examples, the manufacturer inserts a plug into an opening defined by the septum to seal the septum for the service life of the insulating glass unit. This can provide a mechanical seal between the exterior surface of the plug in the wall surface of the septum. Additionally or alternatively, the user may apply a chemical sealant in and/or the septum to seal the septum for the service life of the insulating glass unit.

In addition to or in lieu of configuring an insulating glass unit with a septum penetrable to withdraw insulating gas from or introduce insulating gas into the between-pane space, an insulating glass unit according to the disclosure may be configured with a valve operable to pressure adjust between the between-pane space and ambient environment. In some examples, the valve is a two-way valve operable to discharge insulating gas from the between-pane space when the ambient pressure is lower than the gas pressure in the between-pane space and also operable to allow ambient air to enter the between-pane space when the ambient pressure is greater than the gas pressure in the between-pane space. In other examples, the valve may be a one-way valve operable to discharge insulating gas from the between-pane space when the ambient pressure is lower than the gas pressure in the between-pane space but not operable to allow ambient air to enter the between-pane space when the ambient pressure is greater than the gas pressure in the between-pane space, or vice versa.

During fabrication, the between-pane space of the insulating glass unit can be filled with an insulating gas and sealed by a spacer to define a gas fill pressure in the between-pane space. A valve can be installed on the insulating glass unit during fabrication, with the valve providing selective fluid communication between the between-pane space in the ambient environment. The insulating glass unit may be fabricated with a gas fill pressure substantially equal to the ambient pressure at the location of manufacture of the insulating glass unit. After fabrication, the insulating glass unit can be transported to a different elevation than the elevation at which the insulating glass unit is manufactured having a different ambient pressure than the ambient pressure at the location of manufacture. In response to the pressure differential between the gas pressure in the between-pane space and the ambient pressure, the valve can open to allow insulating gas to discharge from the between-pane space and/or to allow ambient air to enter into the between-pane space (there by mixing with the insulating gas already in the between-pane space).

While the valve can be positioned at a number of locations on the insulating glass unit, in some configurations, the valve is carried by a spacer key of the insulating glass unit. As discussed above, the spacer key can be used to join to opposed ends of a tubular spacer together to form a resultant spacer structure having a completely closed perimeter. The spacer key may include a first key end insertable into a first open end of the tubular spacer, a second key end insertable into a second open end of the tubular spacer, and an intermediate region extending between the first and second ends of the tubular spacer. The valve may be in fluid communication with an opening extending through the intermediate region of the spacer key. For example, the valve may be positioned in the intermediate region the spacer key with an inlet and an outlet on opposite sides of the key. As another example, the valve may be positioned inside or outside of the between-pane space and fluidly connected across the spacer key to the ambient environment or inside of the between-pane space, respectively. Configuring the spacer key to carry the valve may provide manufacturing efficiency and structural rigidity benefits, such as those discussed above in connection with configuring a spacer key to carry a septum. In other examples, an opening is formed through a face of one of the panes defining the insulating glass unit and the valve is fluidly connected to the opening (e.g., by inserting a stem portion of the valve through the opening while a head portion of the valve remains on an outside face of the pane).

In any configuration utilizing a valve, once the insulating glass unit is at a final location of use and the between-pane space has been pressure adjusted with an ambient environment, fluid communication through the valve and/or opening fluidly connected to the valve may be permanently sealed to ensure the between-pane space means sealed for the service life of the insulating glass unit. The valve may be permanently sealed using a plug, chemical sealant layer, and/or other sealing arrangements. Additionally or alternatively, the valve may be removed from the insulating glass unit (e.g., leaving a residual opening that the valve was previously coupled to) and the opening sealed a plug, chemical sealant layer, and/or other sealing arrangements.

In addition to or in lieu of configuring an insulating glass unit with a septum or valve to control pressure in the between-pane space, an insulating glass unit may be configured with an opening that is temporarily sealed and can be unsealed to pressure adjust the between-pane space. For example, the insulating glass unit may be fabricated from one or more panes having an opening extending through a face of the pane. The opening can be temporarily sealed, e.g., with a plug, tape, film, and/or other removable sealant. The insulating glass unit can be fabricated with a gas fill pressure substantially equal to the ambient pressure at the location of manufacture of the insulating glass unit. After fabrication, the insulating glass unit can be transported to a different elevation than the elevation at which the insulating glass unit is manufactured having a different ambient pressure than the ambient pressure at the location of manufacture. The temporary seal can then be removed from the opening to allow the between-pane space to pressure adjust (e.g., equalize) with an ambient environment, e.g., by allowing insulating gas to discharge from the between-pane space through the opening or by allowing ambient air to enter through the opening into the between-pane space.

After the between-pane space has suitably pressure adjusted with the ambient environment, the opening can be sealed. Where the insulating glass unit is at a final use location and elevation, the opening may be permanently sealed for the service life of the insulating glass unit. Where the insulating glass unit is to be transported to yet a further location and elevation, the opening may be again temporarily sealed to allow further pressure equalization at one or more subsequent locations and elevations. In either case, once the insulating glass unit has been transported to a final delivery location and elevation (e.g., where the insulating glass unit is intended to be installed in a building), the opening providing access to the between-pane space may be permanently sealed for the service life of the insulating glass unit.

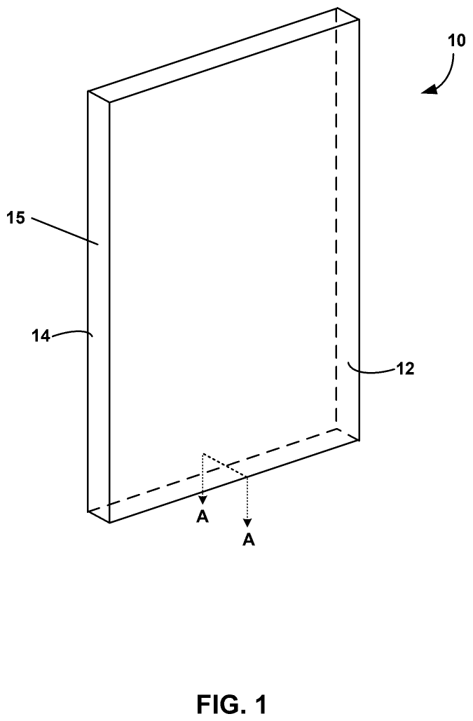

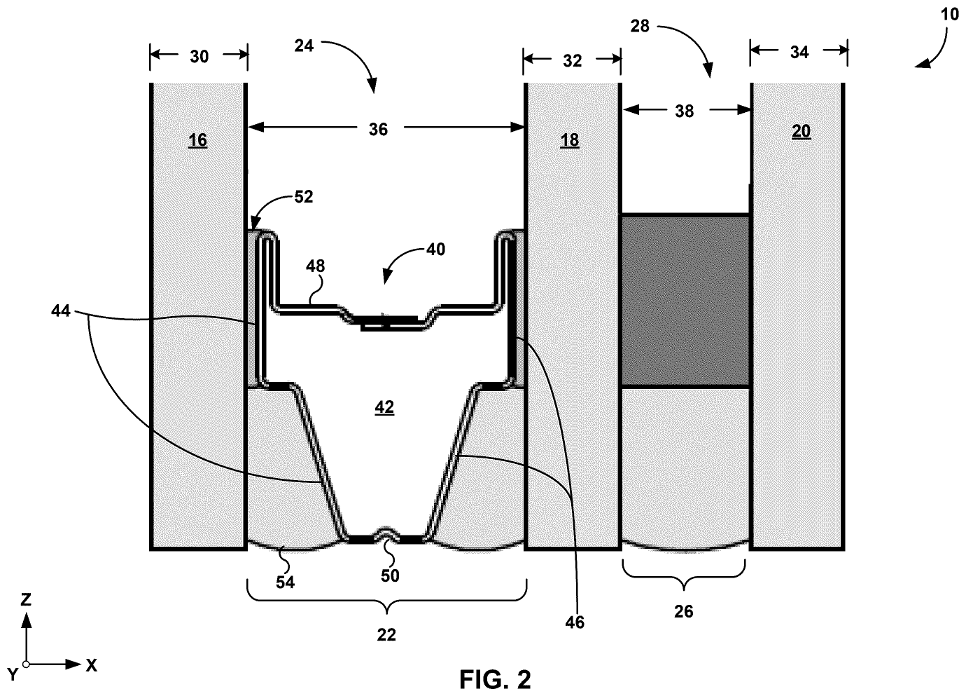

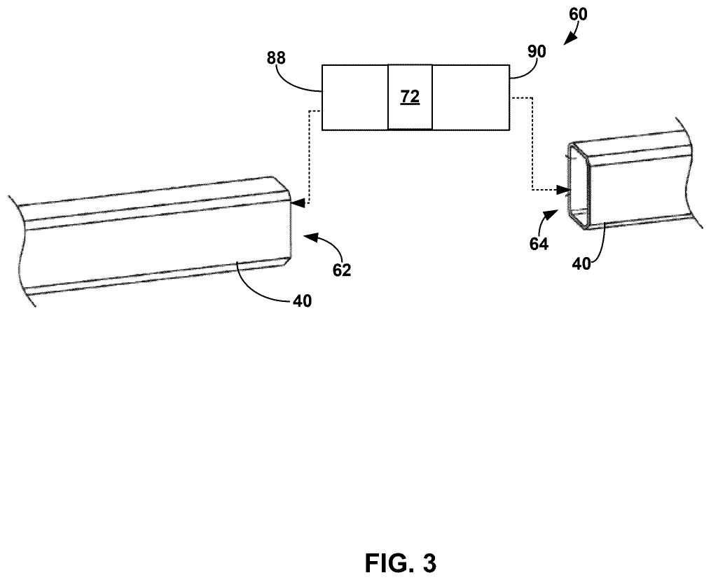

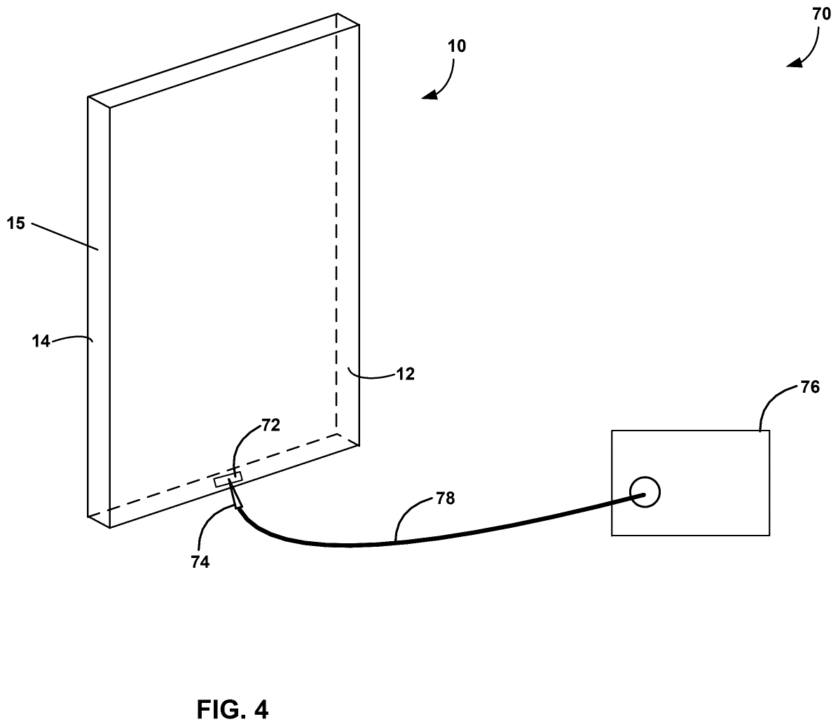

A variety of different insulating glass unit systems, configurations, and techniques that can be implemented to pressure adjust the gas pressure of the between-pane space will be described with respect to FIGS. 4-14. However, example features of an insulating glass unit that may be implemented on various configurations of the disclosure will first be described with respect to FIGS. 1 and 2, and an example spacer key configuration will be described with respect to FIG. 3.

FIG. 1 is a perspective drawing of an example insulating glass unit 10 that may provide an optically transparent and thermally insulating structure that can be mounted in the wall of a building. Insulating glass unit 10 defines a front surface 12 and a back surface 14. Insulating glass unit 10 includes at least two substrates separated by a spacer to define at least one between-pane space. The at least two substrates may be held apart from one another by a spacer that extends about a common perimeter 15 of the substrates and that hermetically seals the between-pane space created between the two substrates. Discussion to the spacer hermetically sealing the between-pane space refers to the spacer providing suitable pressure isolation between the between-pane space and ambient environment over the service life of the unit. In practice, some inherent gas loss through or around the spacer may be exhibited over the service life of the unit, as normally observed in commercial practice, such that the spacer does not provide a perfect hermetic seal.

FIG. 2 is a cross-sectional view of an edge of insulating glass unit 10 taken along the A-A cross-sectional line indicated on FIG. 1. In this example, insulating glass unit 10 includes a first pane of transparent material 16, a second pane of transparent material 18, and a third pane of transparent material 20. The first pane of transparent material 16 is spaced apart from the second pane of transparent material 18 by a first spacer 22 to define a first between-pane space 24. The second pane of transparent material 18 is spaced apart from the third pane of transparent material 20 by a second spacer 26 to define a second between-pane space 28. First spacer 22 may extend around the entire perimeter 15 (FIG. 1) of insulating glass unit 10 to hermetically seal the first between-pane space 24 from gas exchange with a surrounding environment. Second spacer 26 may extend around the entire perimeter 15 of insulating glass unit 10 to hermetically seal the second between-pane space 28 from gas exchange with the surrounding environment. While FIG. 2 illustrates an example triple pane insulating glass unit having three panes of transparent material and two between-pane spaces, the configurations of the disclosure can be implemented on double pane insulating glass units having two panes of transparent material and a single between-pane spaces or quad or more units, and the disclosure is not limited in this respect.

In the example of FIG. 2, insulating glass unit 10 has three panes of transparent material: first pane of transparent material 16, second pane of transparent material 18, and third pane of transparent material 20. Each pane of transparent material may be formed from the same material, or at least one of the first pane of transparent material 16, the second pane of transparent material 18, and the third pane of transparent material 20 may be formed of a material different than one or both of the other panes of transparent material. In some examples, at least one (and optionally all) the panes of insulating glass unit 10 are formed of glass. In other examples, at least one (and optionally all) the panes of insulating glass unit 10 are formed of plastic such as, e.g., a fluorocarbon plastic, polypropylene, polyethylene, or polyester. In still other examples, at least one (and optionally all) the panes of insulating glass unit 10 are formed from multiple different types of materials. For example, the panes may be formed of a laminated glass, which may include two panes of glass bonded together with polyvinyl butyral. When insulating glass unit 10 does not include panes of glass, the unit may be referred to as an insulating unit or insulating glazing unit instead of an insulating glass unit, although the phrase insulating glass unit is generally used in this disclosure to refer to multi-pane insulating structures regardless of the specific materials used to fabricate the panes of the structures.

In one example, at least one (and optionally all) the panes of insulating glass unit 10 are constructed of glass. In various examples, the glass may be aluminum borosilicate glass, sodium-lime (e.g., sodium-lime-silicate) glass, or another type of glass. In addition, the glass may be clear or the glass may be colored, depending on the application. Although the glass can be manufactured using different techniques, in some examples the glass is manufactured on a float bath line in which molten glass is deposited on a bath of molten tin to shape and solidify the glass. Such an example glass may be referred to as float glass.

Independent of the specific materials used to form the first pane of transparent material 16, the second pane of transparent material 18, and the third pane of transparent material 20, the panes can have a variety of different sizes and shapes. In some applications, such as some window and door applications, the first pane of transparent material 16, the second pane of transparent material 18, and the third pane of transparent material 20 each define a planar substrate that is rectangular or square in shape. For example, the first pane of transparent material 16, the second pane of transparent material 18, and the third pane of transparent material 20 may each define a planar substrate that is rectangular or square in shape and has a major dimension (e.g., width or length) greater than 0.5 meters (m) such as, e.g., greater than 1 m, greater than 2 m, or between 0.5 m and 2 m. In general, the panes of insulating glass unit 10 may define any suitable size and shape, and the disclosure is not limited to the example of an insulating glass unit that has rectangular or square panes of any particular size. In addition, while each pane of insulating glass unit 10 may define the same size and shape (e.g., in the Y-Z plane indicated on FIG. 2) in some examples, in other examples, at least one of the first pane of transparent material 16, the second pane of transparent material 18, and the third pane of transparent material 20 may define a size or shape that is different than one or both of the other panes of transparent material.

Depending on application, the first pane of transparent material 16, the second pane of transparent material 18, and/or the third pane of transparent material 20 may be coated with one or more functional coatings to modify the performance of the transparent panes. Example functional coatings include, but are not limited to, low emissivity coatings and photocatalytic coatings. In general, a low emissivity coating is a coating that is designed to allow near infrared and visible light to pass through a pane while substantially preventing medium infrared and far infrared radiation from passing through the panes. A low emissivity coating may include one or more layers of infrared-reflection film interposed between two or more layers of transparent dielectric film. The infrared-reflection film may include (or, in other examples, consist or consist essentially of) a conductive metal like silver, gold, or copper. A photocatalytic coating, by contrast, may be a coating that includes a photocatalyst, such as titanium dioxide. In use, the photocatalyst may exhibit photoactivity that can help self-clean the panes after installation.

In some examples, first pane thickness 30, second pane thickness 32, and third pane thickness 34 are each the same thickness. In other examples, at least one of first pane thickness 30, second pane thickness 32, and third pane thickness 34 is different than one or both of the other pane thicknesses. Example pane thicknesses may be within a range from 1 mm to 6 mm, such as from 2 mm to 4 mm.

Insulating glass unit 10 in the example of FIG. 2 includes first between-pane space 24 and second between-pane space 28. First between-pane space 24 is a space between the first pane of transparent material 16 and the second pane of transparent material 18. First spacer 22 holds the first pane of transparent material 16 apart from the second pane of transparent material 18 to define the first between-pane space 24. Second between-pane space 28 is a space between the second pane of transparent material 18 and the third pane of transparent material 20. Second spacer 26 holds the second pane of transparent material 18 apart from the third pane of transparent material 20 to define the second between-pane space 28.

First between-pane space 24 and second between-pane space 28 of insulating glass unit 10 can have a variety of different sizes and the sizes can vary, e.g., depending on the application for which the insulating glass unit is designed to be used. In the example of FIG. 2, first spacer 22 holds the first pane of transparent material 16 a first separation distance 36 from the second pane of transparent material 18 to define first between-pane space 24. Second spacer 26 holds the second pane of transparent material 18 a second separation distance 38 from the third pane of transparent material 20 to define second between-pane space 28. First separation distance 36 may be the shortest distance between the surface of the first pane of transparent material 16 facing the first between-pane space 24 and an opposing surface of the second pane of transparent material 18 facing the first between-pane space. Similarly, second separation distance 38 may be the shortest distance between the surface of the second pane of transparent material 18 facing the second between-pane space 28 and an opposing surface of the third pane of transparent material 20 facing the second between-pane space.

In some examples, first separation distance 36 is the same as second separation distance 38 such that first between-pane space 24 is the same size as second between-pane space 28. In other examples, first separation distance 36 is different than second separation distance 38. Example separation distances may be within a range from 4 mm to 25, such as from 6 mm to 22 mm, or from 8 mm to 10 mm. For panes with comparatively small between-pane spaces, the separation distance may be less then 8.0 mm, such as less than 7.0 mm (e.g., 6.5 mm), less than 6.0 mm, or less than 5.0 mm.

When configured with multiple between-pane spaces, the pressure control devices and techniques of the disclosure can be applied to each between-pane space or less than all of the between-pane spaces. For example, each pane space may include a septum, value, and/or opening through with the between-pane space can pressure adjust. Alternatively, one of the pane spaces may include a septum, value, and/or opening through with the between-pane space that can pressure adjust while the other between-pane space remains hermetically sealed and does not pressure adjust in respect to changing atmospheric pressure. In yet other examples, insulating glass unit 10 may be configured so that there is an aperture extending from first between-pane space 24 to second between-pane space 28 (e.g., through second pane of transparent material 18) so that first between-pane space 24 is in pressure (e.g., gas) communication with the second between-pane space 28. The aperture may equalize pressure between the first between-pane space 24 and the second between-pane space 28. If a pressure differential is generated between the first between-pane space 24 and the second between-pane space 28, gas can flow through the aperture to pressure equalize between the two between-pane spaces. In these examples, one of the between-pane spaces may include a septum, value, and/or opening in selective communication with an exterior environment through which gas can exchange with the ambient environment. The second between-pane space may pressurize equalize with the between-pane space in selective communication with the exterior environment to also pressure adjust that second between-pane space.

Independent of the specific configuration of first between-pane space 24 and second between-pane space 28, the between-pane spaces may be filled with any desired type of gas. In some examples, at least one (and optionally all) the between-pane spaces of insulating glass unit 10 are filled with an insulating gas. Example insulating gases include argon, krypton, xenon, dry air, and mixtures thereof. In one example, the between-pane spaces are filled with a mixture that includes greater than 50 volume percent argon and a balance volume percentage dry air such as, e.g., greater than 75 volume percent argon and a balance percentage dry air.

Insulating glass unit 10 in the example of FIG. 2 includes first spacer 22 and second spacer 26. First spacer 22 and second spacer 26 may each be any structure that holds opposed panes of transparent material in a spaced apart relationship over the service life of insulating glass unit 10 and seals a between-pane space between the opposed panes of transparent material, e.g., so as to inhibit or eliminate gas exchange between the between-pane space and an environment surrounding insulating glass unit 10. In some examples, first spacer 22 has the same design as second spacer 26. First spacer 22 may have the same design as second spacer 26 in that both spacers may be fabricated from the same types of components, e.g., with the components of each spacer being arranged in the same position relative to other components in the spacer, as compared to the other spacer. In other examples, first spacer 22 has a different design than second spacer 26. For example, first spacer 22 may be fabricated from different components than second spacer 26 and/or the components of first spacer 22 may be arranged in a different position relative to other components in the spacer, as compared to second spacer 26.

In the example of FIG. 2, first spacer 22 includes a tubular spacer 40 that is positioned between the first pane of transparent material 16 and the second pane of transparent material 18. Tubular spacer 40 defines a hollow lumen or tube 42 which, in some examples, is filled with desiccant (not illustrated in FIG. 2). Tubular spacer 40 includes a first side surface 44, a second side surface 46, a top surface 48 connecting first side surface 44 to second side surface 46, and a bottom surface 50 also connecting first side surface 44 to second side surface 46. First side surface 44 of tubular spacer 40 is positioned adjacent the first pane of transparent material 16 while second side surface 46 of the tubular spacer is positioned adjacent the second pane of transparent material 18. Top surface 48 is exposed to the first between-pane space 24. In some examples, top surface 48 of tubular spacer 40 includes openings that allow gas within first between-pane space 24 to communicate into lumen 42. When tubular spacer 40 is filled with desiccating material, gas communication between first between-pane space 24 and lumen 42 can help remove moisture from within the first between-pane space, helping to prevent condensation between the panes.

In addition, first spacer 22 in the example of FIG. 2 includes at least one sealant positioned between tubular spacer 40 and opposing panes of insulating glass unit 10. In particular, in the example of FIG. 2, first spacer 22 is illustrated as including a primary sealant 52 and a secondary sealant 54. Primary sealant 52 is positioned between a portion of first side surface 44 extending substantially parallel to the first pane of transparent material 16 and a portion of second side surface 46 extending substantially parallel to the second pane of transparent material 18. Secondary sealant 54 is positioned between a portion of first side surface 44 diverging away from the first pane of transparent material 16 and a portion of second side surface 46 diverging away from the second pane of transparent material 18.

Tubular spacer 40 may be a rigid structure that holds the first pane of transparent material 16 apart from the second pane of transparent material 18 over the service life of insulating glass unit 10. In different examples, tubular spacer 40 is fabricated from aluminum, stainless steel, a thermoplastic, or any other suitable material. In addition, while tubular spacer 40 is generally illustrated as defining a W-shaped cross-section (i.e., in the X-Z plane indicated on FIG. 2), tubular spacer 40 can define any polygonal (e.g., square, hexagonal) or arcuate (e.g., circular, elliptical) shape, or even combinations of polygonal and arcuate shapes.

Primary sealant 52 may contact and adhere first side surface 44 of tubular spacer 40 to the first pane of transparent material 16 and may also contact and adhere second side surface 46 of tubular spacer 40 to the second pane of transparent material 18. Because first spacer 22 is generally configured to hermetically seal first between-pane space 24, primary sealant may be selected to prevent moisture from entering first between-pane space 24 and also to prevent gas from escaping from first between-pane space (when the first between-pane space is filled with gas). Secondary sealant 54 may help seal the first between-pane space 24 from gas communication with an environment surrounding insulating glass unit 10. Secondary sealant 54 may also help maintain a substantially constant first separation distance 36 between the first pane of transparent material 16 and the second pane of transparent material 18 over the service life of insulating glass unit 10. For example, secondary sealant 54 may be selected as a material that resists compression over the service life of insulating glass unit 10.

Example materials that may be used as primary sealant 52 include, but are not limited to, extrudable thermoplastic materials, butyl rubber sealants (e.g., polyisobutylene-based thermoplastics), polysulfide sealants, and polyurethane sealants. In some examples, primary sealant 52 is formed from a butyl rubber sealant that includes silicone functional groups or a polyurethane sealant that includes silicone functional groups. Example materials that may be used as secondary sealant 54 include acrylate polymers, silicone-based polymers, extrudable thermoplastic materials, butyl rubber sealants (e.g., polyisobutylene-based thermoplastics), polysulfide sealants, polyurethane sealants, and silicone-based sealants. For example, secondary sealant 54 may be formed from a butyl rubber sealant that includes silicone functional groups or a polyurethane sealant that includes silicone functional groups. In some examples, the composition of primary sealant 52 is the same as the composition of secondary sealant 54. In other examples, the composition of primary sealant 52 is different than the composition of secondary sealant 54. In one example, primary sealant 52 is a butyl rubber-based sealant and secondary sealant 54 is a silicone-based sealant.

Although first spacer 22 in the example of FIG. 2 includes primary sealant 52 and secondary sealant 54, in other examples, first spacer 22 may include fewer sealants (e.g., a single sealant) or more sealants (e.g., three, four, or more). In addition, other arrangements of primary sealant 52 and secondary sealant 54 relative to tubular spacer 40 are both possible and contemplated. For instance, in some examples, first spacer 22 includes additional secondary sealant 54 covering bottom surface 50 of tubular spacer 40 (e.g., so as to contact bottom surface 50 while extending continuously between the first pane of transparent material 16 and the second pane of transparent material 18). In other examples, such as the example illustrated in FIG. 2, secondary sealant 54 is not positioned adjacent bottom surface 50 of tubular spacer 40.

The design of first spacer 22 illustrated with respect to FIG. 2 is merely one example. In other examples, first spacer 22 may be formed from a corrugated metal reinforcing sheet surrounded by a primary sealant composition. The corrugated metal reinforcing sheet may be a rigid structural component that holds the first pane of transparent material 16 apart from the second pane of transparent material 18. In some examples, a secondary sealant composition also applied in contact with an outer surface of the primary sealant composition. Example spacers with a corrugated metal reinforcing sheet include the Duralite® spacer and Duraseal®, both available from Quanex.

In another example, first spacer 22 may be formed from a foam material surrounded on all sides except a side facing first between-pane space 24 with a metal foil. Such a spacer is commercially available from Quanex under the trade name Super Spacer®. In yet another example, first spacer 22 may be a thermoplastic spacer (TPS) spacer formed by positioning a primary sealant between the first pane of transparent material 16 and the second pane of transparent material 18. A secondary sealant may then be applied around the perimeter defined between first pane of transparent material 16 and the second pane of transparent material 18, in contact with the primary sealant. First spacer 22 can have other configurations, including the configuration of second spacer 26 as described herein, as will be appreciated by those of ordinary skill in the art.

Depending on the configuration of the spacer, a spacer according to the disclosure may have ends joined together by a spacer key. FIG. 3 is a schematic illustration of an example configuration of a tubular spacer 40 (which can be used as first spacer 22 and/or second spacer 26) having opposed ends joined together by a spacer key 60. As mentioned above in connection with FIG. 2, spacer 40 may surround the perimeter of insulating glass unit 10 to define a hermetically sealed between-pane space. Spacer 40 may be formed of a single, unbroken, and/or unitary spacer member having first and second opposed and/or open ends 62 and 64 that join together at opposite ends of the single spacer member by spacer key 60. Alternatively, spacer 40 may include multiple spacer segments each joined together (e.g., with spacer keys). In either case, spacer key 60 may be formed of a section of material of the same or different composition than tubular spacer 40. Spacer key 60 can be configured an installed along a straight length of tubular spacer 40 (e.g., such that the spacer key extends linearly). Spacer key 60 can also be configured to be installed at a corner of tubular spacer 40 (e.g., such that the spacer key defines an approximately 90 angle and is positionable at the corner of the spacer).

Spacer key 60 is insertable into opposed ends 62 and 64 of the tubular spacer 40 to join the spacer together and form a closed structure extending around the perimeter of the glazing assembly. For example, spacer key 60 can have first and second end portions having a cross-sectional size and/or shape substantially equivalent to tubular spacer 40, e.g., with a first end 66 size and shape indexed to fit inside first end 62 of the tubular spacer and a second end 68 size and shape indexed to fit inside second end 64 of the spacer.

Independent of the specific configuration of tubular spacer 40, spacer key 60 can be a component that bridges the gap between the opposed ends 62, 64 of the tubular spacer, which may be ends of a single, unitary spacer body or ends of different individual spacer members. The ends 88, 90 of spacer key 60 may include projections, detents, or other mechanical engagement features to help keep the spacer key retained in tubular spacer 40 once inserted. In some examples, spacer key 40 is formed of a polymeric material (e.g., while tubular spacer 40 is formed of metal such as aluminum or stainless steel), although other materials can be used. For example, spacer key 60 can be formed of metal such as aluminum or stainless steel. In general, the thickness of the material forming spacer key 60 may be thicker than the material thickness of tubular spacer 40.

As discussed above, the one or more between-pane space of insulating glass unit 10 may be filled with an insulating gas (e.g., mixture of multiple gases during manufacture of the insulating glass unit). An insulating gas inside insulating glass unit 10 can reduce heat transfer across the unit as compared to if the unit does not contain insulating gas. To introduce the insulating gas into unit 10 during manufacture, the first pane of transparent material 16 and the second pane of transparent material 18 may be brought into a generally parallel and spaced apart relationship. Tubular spacer 40 having opposed ends 62 and 64 joined together by spacer key 60 may be adhered to the perimeter of one of the panes of transparent material (e.g., first pane of transparent material 16) but not the other of the panes of transparent material. The insulating gas (e.g., mixture of gases) can then be injected into the space between the first pane of transparent material 16 and second pane of transparent material 18 so as to displace any ambient gas (e.g., air) otherwise present between the two panes of transparent material. With the space between the two panes of transparent material filled with the introduced gas, the first pane of transparent material 16 and second pane of transparent material 18 can be pressed together, thereby sealing the gas mixture inside insulating glass unit 10. An example system and technique for assembling and gas filling an insulating glass unit is described in U.S. Pat. No. 11,168,515, titled “MULTIPLE-PANE INSULATING GLAZING UNIT ASSEMBLY, GAS FILLING, AND PRESSING MACHINE” and granted on Nov. 9, 2021, the entire contents of which are incorporated herein by reference.

In practice, insulating glass units are often filled with insulating gas so that the pressure of the gas sealed inside the unit is at the same pressure or substantially the same pressure as ambient gas outside of the unit. That is, the insulating glass unit may be filled so that the gas pressure inside the unit is not at a highly positive pressure or a highly negative pressure relative to air pressure outside of the unit but rather is substantially equal to air pressure surrounding the exterior of the unit (e.g., plus or minus 5% or less of ambient pressure, such as plus or minus 1% or less of ambient pressure, or plus or minus 0.1% or less of ambient pressure). When the gas pressure inside the insulating glass unit is substantially equal to the air pressure outside of the unit, the forces acting on opposite sides of the transparent panes of the insulating glass unit may generally be in balance so there is little to no net pressure force acting to push the panes of the insulating glass unit inwards or outwards. By constructing the insulating glass unit so that the pressure of the gas inside the unit is substantially equal to the air pressure outside of the unit, the unit may experience less stress on the spacer than if there is a pressure imbalance.

In some applications, insulating glass unit 10 may be manufactured so that the pressure of the insulating gas inside the unit is substantially equal to (or, in other examples, equal to) the air pressure outside of the unit at the location of manufacture. If the insulating glass unit is desired to be used at a location where the ambient pressure outside of the insulating glass unit is different (greater or less) than the ambient pressure at the location of manufacture, a pressure imbalance may arise between the gas pressure inside the unit and ambient pressure outside of the unit, unless the gas pressure inside the unit is adjusted relative to the initial gas fill pressure at the time of manufacture.

A gas pressure imbalance can arise if an insulating glass unit is manufactured at one elevation with respect to sea level and then transported to the different elevation. For example, when the insulating glass unit is manufactured at a first elevation and transported to a second elevation higher than the first elevation, a pressure imbalance may exist whereby the gas pressure in the between-pane space is greater than the ambient pressure at the second elevation. This may cause the panes of transparent material to bow outwardly relative to a normal, parallel orientation when the between-pane space is pressure balanced with the ambient environment. As another example, when the insulating glass unit is manufactured at a first elevation and transported to a second elevation lower than the first elevation, a pressure imbalance may exist whereby the gas pressure in the between-pane space is less than the ambient pressure at the second elevation. This may cause the panes of transparent material to bow inwardly relative to a normal, parallel orientation when the between-pane space is pressure balanced with the ambient environment.

In general, insulating glass unit 10 can be manufactured at any desired elevation and then transported to any other desired elevation, e.g., for end use where the insulating glass unit is installed in a building wall opening. In various examples, the difference in elevation between the location of manufacture and a target elevation where the insulating glass unit 10 is intended to be used is at least 1000 feet, such as at least 2000 feet, at least 3000 feet, at least 5,000 feet, or at least 7500 feet. In some examples, the difference in elevation between the location manufacturer in a target elevation where the insulating glass unit is intended to be used is within a range from 500 feet to 12,500 feet, such as from 1000 feet to 3000 feet, from 2500 feet to 10,000 feet, or from 5000 feet to 10,000 feet. As noted, the location manufacturer can be higher or lower than the target elevation.

The difference in atmospheric pressure at the location of manufacture as compared to atmospheric pressure at the target elevation where the insulating glass unit is delivered and/or intended to be used may vary depending on the elevation difference between the locations. In some examples, the difference in atmospheric pressure between the location of manufacturer in the atmospheric pressure at the target location of delivery and/or use is at least 0.5 pounds per square inch (psi), such as at least 1.0 psi, at least 1.5 psi, at least 2.0 psi, at least 2.5 psi, at least 3.0 psi, at least 3.5 psi, at least 4.0 psi, at least 4.5 psi, or at least 5.0 psi. For example, the difference in atmospheric pressure between the location of manufacture and the atmospheric pressure at the target location may be within a range from 1.0 psi to 7.5 psi, such as from 2.0 psi to 6.0 psi.

In various examples, the atmospheric pressure at the location of manufacture is within a range from 13.0 psi to 14.7 psi, such as from 13.5 psi to 14.5 psi, or from 12.5 psi to 14.0 psi, such as from 13.0 psi to 14.0 psi. The atmospheric pressure at the location of delivery and/or use may be less than 14.0 psi, such as less than 13.5 psi, such as less than 13.0 psi, such as less than 12.5 psi. In some examples, the atmospheric pressure at the location of delivery and/or use may be within a range from 8.0 psi to 13.5 psi, such as from 10.0 psi to 13.2 psi, or from 10.5 psi to 13.0 psi. While an insulating glass unit according to the disclosure is generally described as being filled with insulating gas to a gas fill pressure substantially equal to atmospheric pressure at the location manufacture, it should be appreciated that the gas fill pressure in the between-pane space set at the location of manufacture may be higher or lower than atmosphere during initial filling and assembly.

Various insulating glass unit configurations, techniques, and manufacturing systems may be implemented according to the disclosure to allow for pressure control of the between-pane space after initial fabrication and gas filling of the insulating glass unit to accommodate for pressure changes between the initial gas fill pressure in the between-pane space and subsequent atmospheric pressure.

FIG. 4 is a block diagram illustrating an example configuration of a pressure control system 70 that can be used to adjust the pressure of a between-pane inside of insulating glass unit 10 after initial fabrication and gas filling of the insulating glass unit. In the illustrated example, insulating glass unit 10 is schematically illustrated as including a spacer that includes a septum 72. Septum 72 can provide a partition separating a between-pane space of insulating glass unit 10 from a surrounding external environment. Septum 72 can be penetrated by piercing element 74 (e.g., a needle or other lumen) connected to a gas line 78 to provide selective gas communication with the between-pane space of insulating glass unit 10. Septum 72 is illustrated as being carried by spacer key 60, as will be discussed in more detail.

In the illustrated arrangement of FIG. 4, pressure control system 70 is illustrated as including a pressure control unit 76 in fluid communication with piercing element 74 via a gas line 78. In use, a manufacturer can insert piercing element 74 through septum 72, thereby creating an opening or piercing through the septum and breaching the structural integrity of the septum that provides a barrier gas sealing the between-pane space. Pressure control unit 76 can adjust the gas pressure in the between-pane space by introducing additional gas into the between-pane space or by withdrawing gas from the between-pane space. Septum 72 may be formed of a polymeric material that at least partially seals the opening formed through the septum by piercing element 74 when the piercing element is withdrawn from the septum.

During manufacture of insulating glass unit 10, one or more between-pane spaces of the insulating glass unit can be filled with insulating gas to define a gas fill pressure in the between-pane space. During this initial assembly, the between-pane space can be sealed with spacer 22 to close the between-pane space from gas exchange with a surrounding environment. The gas fill pressure in the between-pane space after this initial manufacturing of the insulating glass unit may be substantially equal to atmospheric pressure at the location of manufacture of the insulating glass unit.

After initially fabricating insulating glass unit 10 with the between-pane space filled with insulating glass at the gas fill pressure (e.g., corresponding to atmospheric pressure at the location manufacture), the gas pressure inside the insulating glass unit can be adjusted using pressure control system 70. Pressure adjustment using pressure control system 70 may be performed at the same location manufacture where the insulating gas unit 10 was initially fabricated and gas-filled, or the insulating gas unit can be transported to a different location at the same, higher, or lower elevation where pressure control system 70 is then used (a secondary location of manufacture). Typically, pressure control system 70 may be used at the same manufacturing location where insulating glass unit 10 is initially fabricated and gas-filled.

After initially fabricating and gas filling insulating glass unit 10 such that the between-pane space is filled with insulating gas at the gas fill pressure, piercing element 74 can be inserted through septum 72 and pressure control unit 76 operated to adjust the pressure inside of the between-pane space. In some examples, pressure control unit 76 includes a vacuum source operable to withdraw the gas from the between-pane space, e.g., to reduce the gas pressure inside the between-pane space to a vacuum pressure relative to atmospheric pressure at the location manufacture. Additionally or alternatively, pressure control unit 76 may be or include a source of gas (e.g., the same insulating gas initially filled into the between-pane space) and can supply the gas under pressure to the between-pane space. This can increase the pressure inside the between-pane space to a positive pressure relative to atmospheric pressure at the location of manufacture.

Pressure control unit 76 can adjust the pressure in the between-pane space of insulating glass unit 10 to any desired pressure. In some implementations, pressure control unit 76 adjusts the pressure in the between-pane space of insulating glass unit 10 to be substantially equal to atmospheric pressure at a target location of delivery and/or final use of the insulating glass unit. Where insulating glass unit 10 is intended to be transported to a higher elevation location, pressure control unit 76 can be operated to reduce the gas pressure in the between-pane space below the gas fill pressure, such as by reducing the gas pressure from 1 pounds per square inch (psi) to 7 psi less than the gas fill pressure, or from 1.5 psi to 5 psi less than the gas fill pressure. Where insulating glass unit 10 is intended to be transported to a lower elevation location, pressure control unit 76 can be operated to increase the gas pressure in the between-pane space above the gas fill pressure, such as by increasing the gas pressure from 1 psi to 5 psi greater than the gas fill pressure, or from 1.5 to 3.5 greater than the gas fill pressure. Other magnitudes of gas pressure adjustment can be implemented, and the disclosure is not limited in this respect.

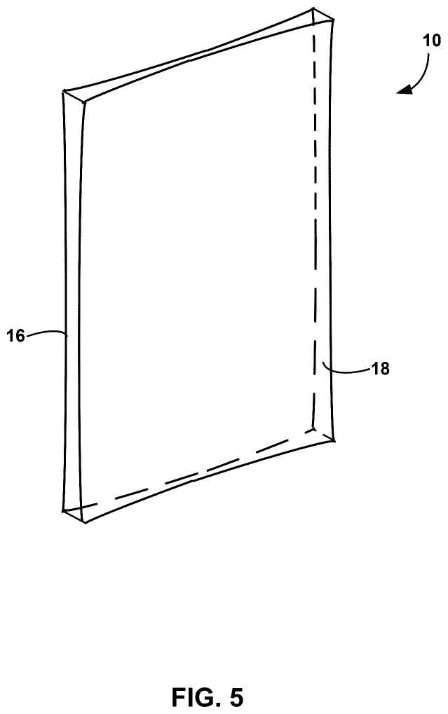

When pressure control unit 76 is operated to increase the gas pressure in the between-pane space above the gas fill pressure, this can cause panes of material bounding the between-pane space (e.g., first pane of transparent material 16 and second pane of transparent material 18) to bow outwardly away from each other. By contrast, when pressure control unit 76 is operated to reduce the gas pressure in the between-pane space below the gas fill pressure, this can cause panes of material bounding the between-pane space (e.g., first pane of transparent material 16 and second pane of transparent material 18) to bow inwardly toward each other. FIG. 5 is a perspective view of insulating glass unit 10 illustrating how panes of material bounding the between-pane space may bow inwardly toward each other in response to reducing the pressure of in the between-pane space below atmospheric pressure (compared to ambient pressure at the location of manufacture). In either case, once insulating glass unit 10 is transported to a target delivery and/or use elevation and location, the pressure in the between-pane space may be substantially equalized with ambient pressure at that location in the panes bounding the between-pane space may return to a parallel alignment with each other.

Piercing element 74 can have a variety of different sizes and configurations. In some examples, piercing element 74 is in the form of a needle defining an annulus through which gas can be introduced through or withdrawn from. Piercing element 74 may terminate in a tapered or sharpened distal point allowing the piercing element to more easily penetrate through septum 72. Piercing element 74 may typically have a cylindrical cross-sectional shape although can have any suitable cross-sectional shape. In some configurations, piercing element 74 as an outer diameter less than 15 mm, such as less than 10 mm, less than 5 mm, or less than 1 mm. After withdrawing piercing element 74 from septum 72, the septum may have a residual opening or piercing that may be closed by the elasticity of material forming the septum returning to cover the opening caused by piercing element 74. As will be discussed, one or more additional sealing materials may also be used to help close gas communication through the septum after piercing element 74 is withdrawn from the septum.

As briefly discussed above, septum 72 can be positioned at a variety of locations along insulating glass unit 10 between a between-pane space defined by the insulating glass unit and a surrounding gas environment. In some implementations, septum 72 is carried by spacer key 60 (FIG. 3) that is used as a component forming spacer 22. When so configured, septum 72 can be installed unpenetrated on spacer key 60 and the combination of spacer key 60 carrying septum 72 connected to tubular spacer 40 to form the resultant spacer 22 that is positioned between opposed panes of transparent material during gas filling assembly of insulating glass unit 10.

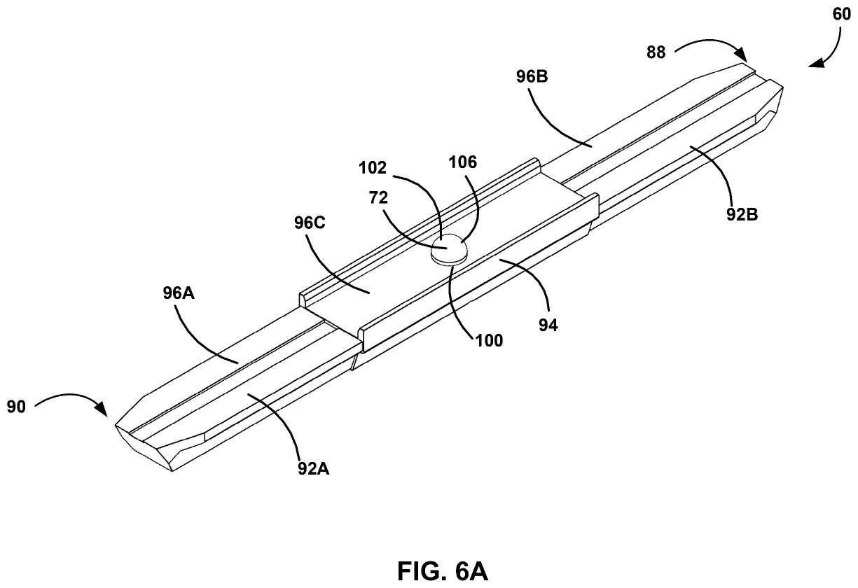

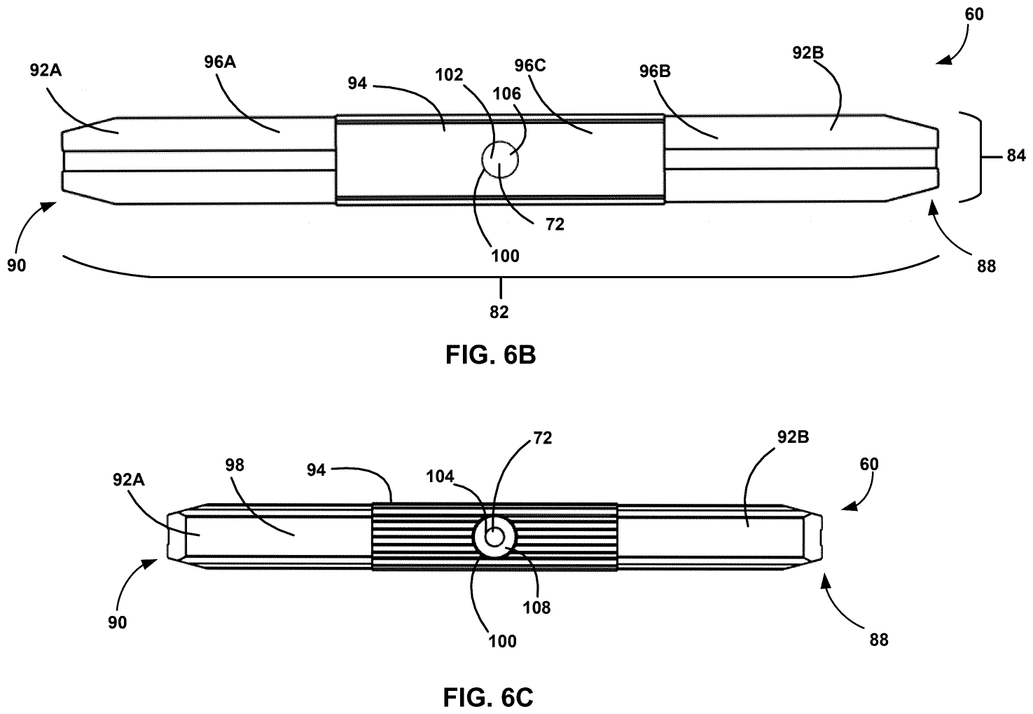

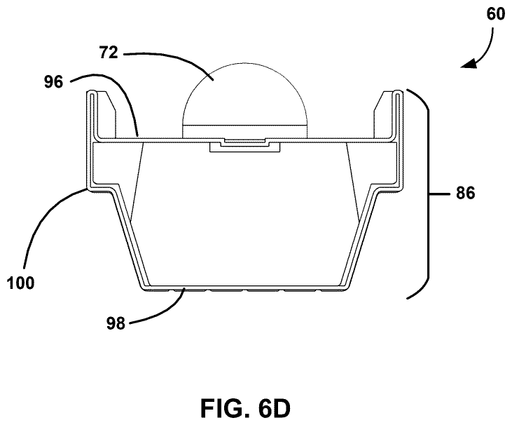

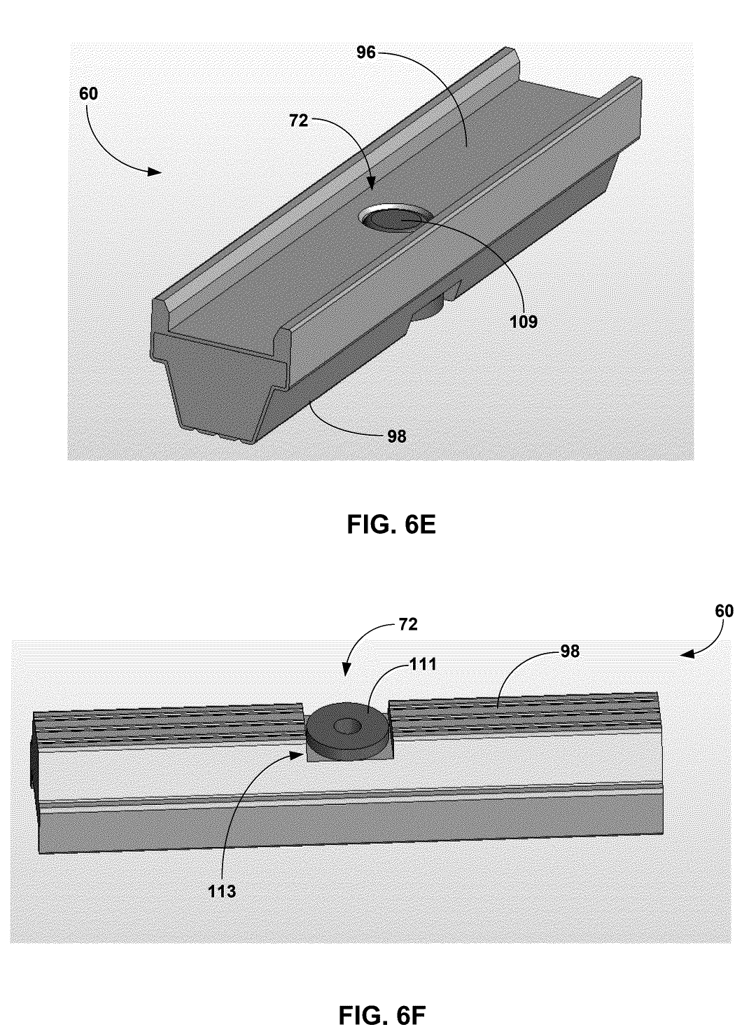

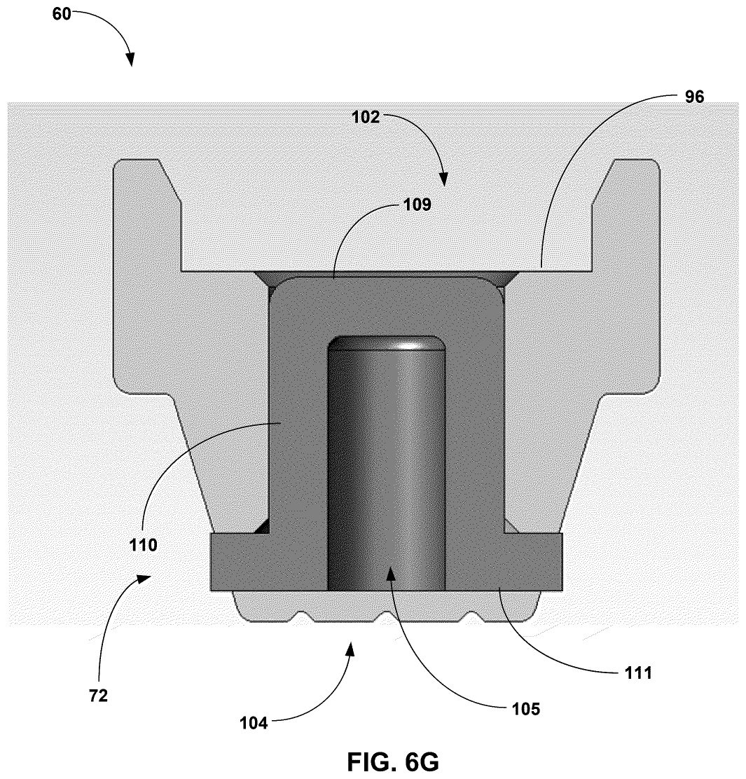

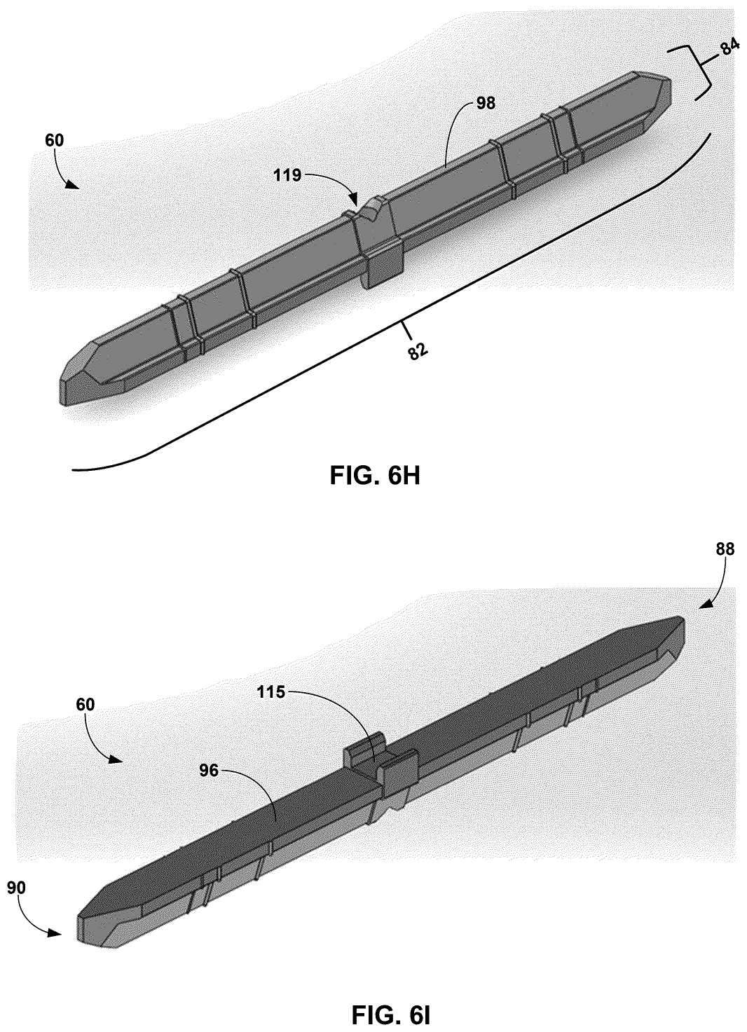

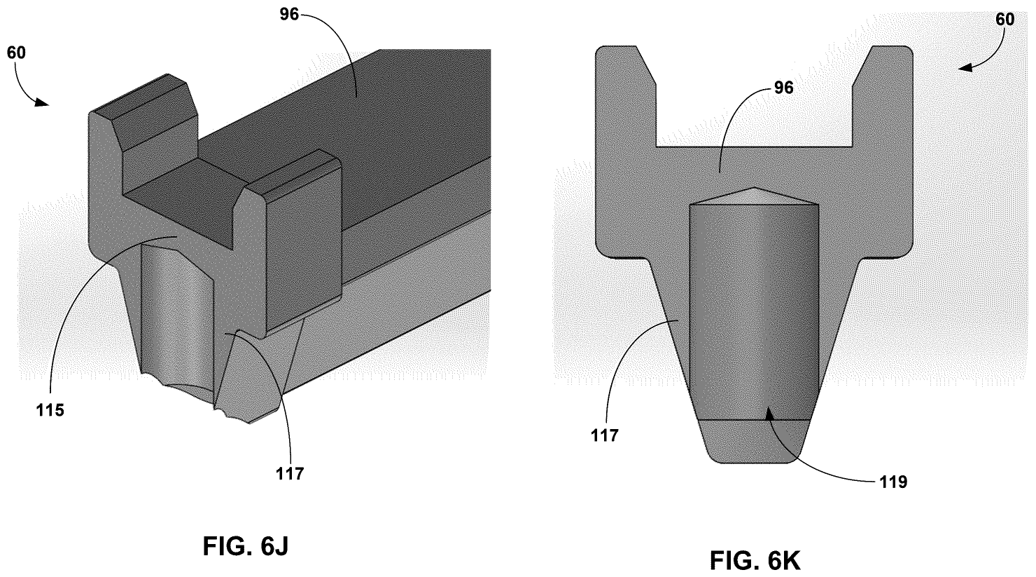

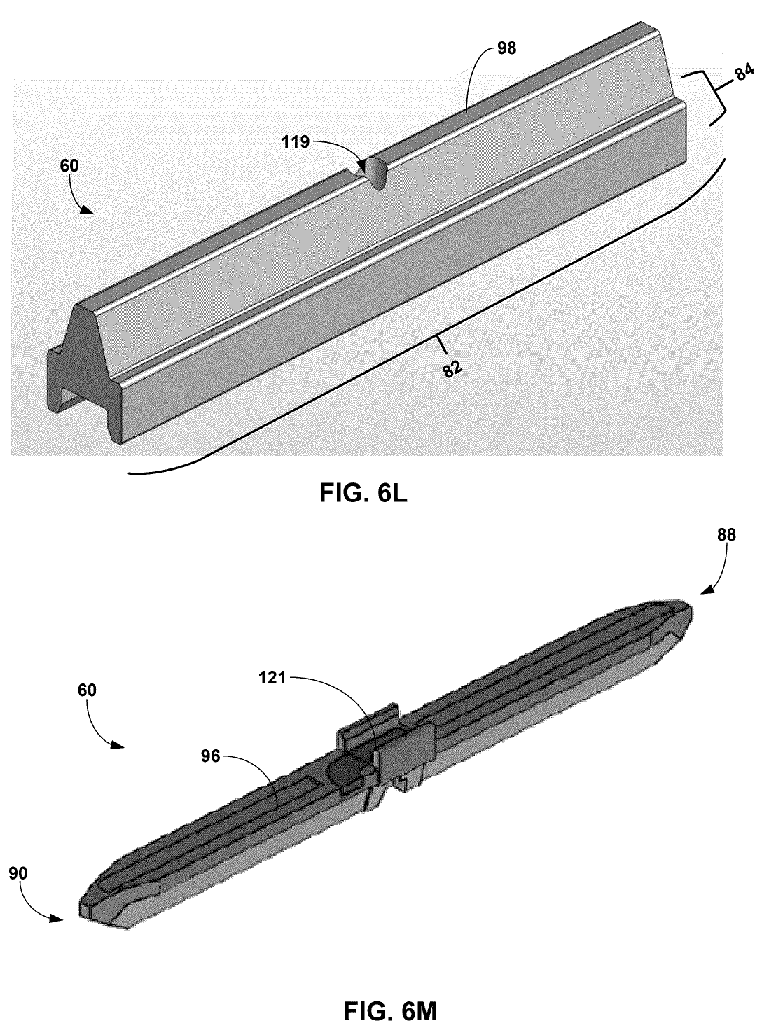

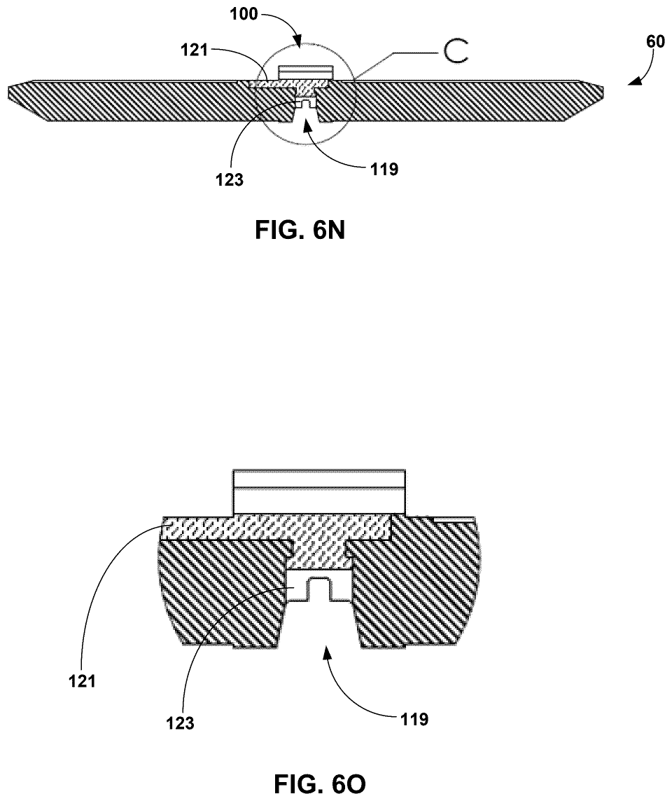

FIGS. 6A-6D (collectively referred to herein as FIG. 6) are different views of an example configuration of spacer key 60 (also referred to herein as a “key”). The spacer key 60 is configured to fit within a spacer of an insulating glass unit. The key 60 has a key length 82, key width 84, and key thickness 86. In some examples, the key length 82 is the length extending from the first key end 88 to the second key end 90. The length 82 of the key 60 can range from about 100 mm to about 150 mm, such as approximately 122 mm. The key width 84 can be the distance from one side of the key 60 to an opposite side of the key 60. In some examples, the key 60 can have a width 84 of about 8 mm to about 15 mm, such as approximately 12 mm. The key 60 can have a thickness 86 defined by the distance from innermost surface to the outermost surface of the key 60. The thickness 86 of the key 60 can vary. In some examples, the thickness 86 of the key 60 at the insertion portion 92 may be less than the thickness of the key 60 at the intermediate portion 94. The thickness 86 of the key 60 can range from about 2 mm to about 10 mm, such as approximately 5.6 mm at the first and second insertion portions 92A, 92B and approximately 5.9 mm at the intermediate portion 94. The key 60 can have a wall thickness within a range from about 0.01 mm to about 10 mm, such as from about 0.1 mm to 0.5 mm, or as approximately 0.2 mm. The key 60 can be made of a metallic material. In some examples, the key 60 can be made of nylon, aluminum, polypropylene, polyethylene, or any other polyolefin.

The spacer key 60 is configured to be inserted into a spacer 22 and can include a variety of features configured for such use. For example, the key 60 can define a first insertion portion 92A configured to be inserted into the first end of the tubular body 40. The key 60 can define a second insertion portion 92B configured to be inserted into the second end of the tubular body 40 of the spacer 22. The first and second insertion portions 92A, 92B can be tapered at the first and second key ends 88, 90. Each key end 88, 90 can be tapered to match the internal diameter of the spacer tubular body 42. In such examples, an intermediate region 94 can be positioned between the first insertion portion 92A and the second insertion portion 92B. The intermediate portion 94 can have a height such that the intermediate portion 94 abuts the outer profile of the spacer 40.

The key 60 can include an inner surface 96 facing the between-pane space and an outer surface 98 facing the external environment. The inner surface 96C of the intermediate portion 94 of the key 60 can be offset from the inner surface 96A of the first insertion portion 92A of the key 60 and from the inner surface 96B of the second insertion portion 92B. In some examples, the inner surface 96B of the intermediate portion 94 of the key 60 can be offset from the inner surface 96A of the first insertion portion 92A of the key 60 and from the inner surface 96B of the second insertion portion 96B of the key 60. The inner surface 96C of the intermediate portion 94 can be substantially co-planar with an inner surface of the tubular body 42 adjacent the first end 88 and the second end 90.

In use, the key 60 can be inserted into the spacer 22. Inserting the key 60 into the spacer 22 can connect each end of the spacer. By connecting the spacer, gas can remain in the between-pane space and the between-pane space can be effectively sealed.

The intermediate portion of the key 60 can include a port 100 configured to receive a septum 72. The port 100 can be an opening within the key 60 extending from the inner surface 96C to the outer surface 98. In such examples, the septum 72 can close an opening within the key 60 such that, when the septum 72 is inserted into the port 100, a gas-tight seal is formed between the septum 72 and the port 100. This can prevent gas from entering and/or escaping the between-pane space. In some examples, the port 100 can have a diameter of about 2 mm to about 8 mm. In other embodiments, the port 100 can have a diameter of about 5 mm.

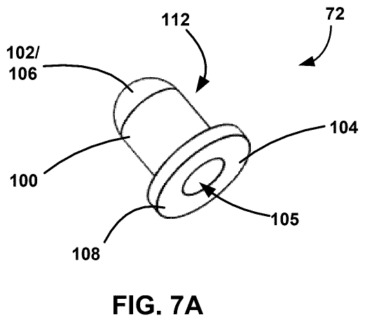

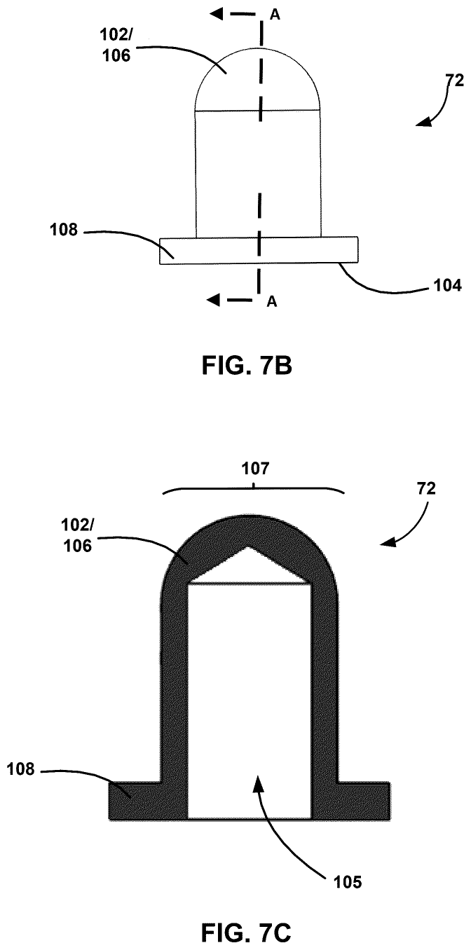

FIG. 7A-7C show a septum 72 configured to be disposed within such a port. The septum 72 can have a variety of features. For example, the septum 72 can have a closed end 102 and an open end 104. The closed end 102 can include a closed end face 106. The open end 104 can include a flange 108. A wall 110 from the closed end 102 to the open end 104 can form a tubular body 112 having a thickness 107. The tubular body 112 can include a cavity 105. The thickness 107 of the tubular body 112 can range from about 1 mm to about 5 mm. In other examples, the thickness 107 can be about 2.5 mm. When the septum 72 is inserted in the port 100, the flange 108 can extend radially from one end of the tubular body 112 and nest or abut against the outer surface 98 of the key 60.

In use, the septum 72 can be pierced to allow the passage of a fluid therethrough. In some examples, the piercing of the septum 72 can occur via needle penetration. The pierce can be located at a location on the septum 72 and can extend through the closed end face 106. The pierce can be used to modify the pressure of the between-pane space, as discussed previously.

The pierce of the septum 72 can be sealed. Sealing the septum 72 prevents additional changes in the pressure of the between-pane space, which allows the space to retain a desired amount of insulative gas. In some examples, the septum 72 can be made of material configured to create an impermeable seal when the septum 72 is sealed. In some examples, the septum 72 can be made of a polymeric material.

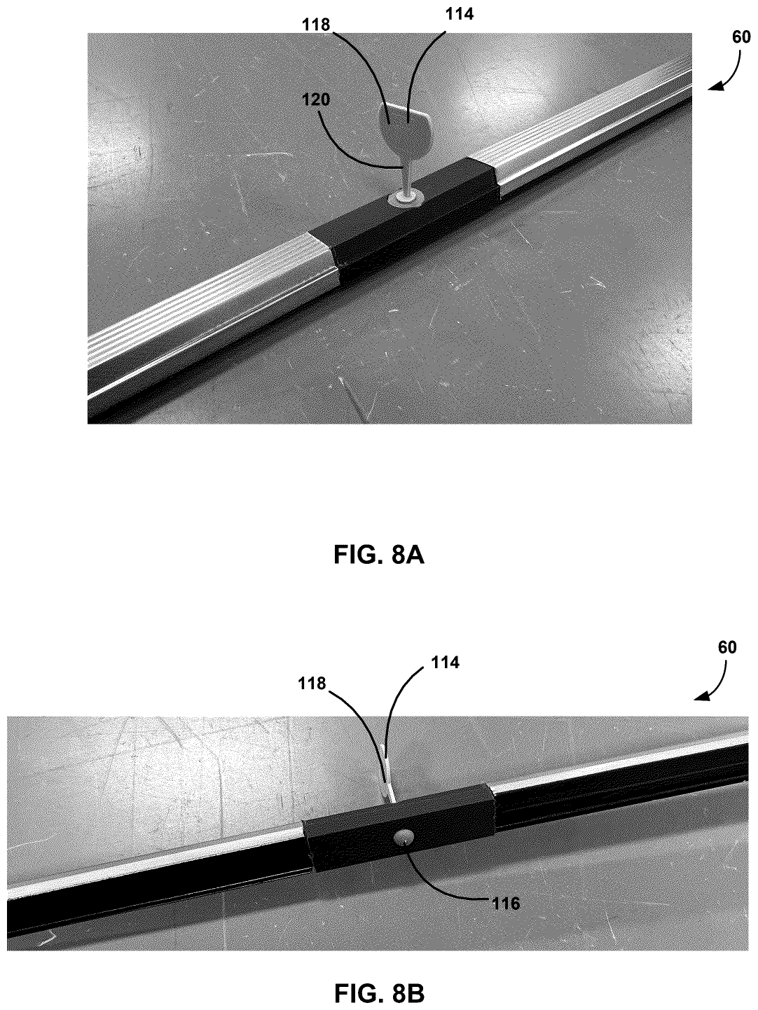

In some examples, the septum 72 can be sealed using sealing material 114. FIGS. 8A and 8B shows an exemplary sealing material 114 in the form of a plug 114. The plug 114 can include a plug head 118 and plug body 120. The plug body 120 can be disposed within the septum 72. The plug head 118 can be manipulated by a user. The plug 114 can be made of plastic and/or metal. In some examples, the plastic can be a hard plastic. In some examples, plug 114 is inserted into the septum 72. In other examples, plug 114 is inserted into the space underlying septum 72 without entering the septum, thereby sealing gas flow through the septum. In either case, the plug 114 can remain in place indefinitely. Plug 114 can form a mechanical seal with an interior wall surface of the material defining septum 72.

The plug can include a variety of features, as shown in FIG. 8B. For example, plug 114 can be is inserted adjacent to and/or in contact with the material defining septum 72, or the plug 114 can be inserted to extend through the pierce of the septum 72 such that an end 116 of the plug 114 protrudes into the between-pane space through the septum 72. In other examples, end 116 of plug 114 may be positioned in contact with a wall surface (e.g., horizontal wall surface) through which septum 72 is pierced or offset from the pierced wall.

Additionally or alternatively, a sealant can be used to a sealing material 114 to seal the pierce. The sealant can be placed over the key 60 and/or in and/or over septum 72 to prevent fluidic communication through the piece. Example sealants that can be used may include those described above as being suitable for primary sealant 52 and/or secondary sealant 54. In some examples, the sealant comprises silicone. That is, the key 60 and septum 72 can be encased in a layer of silicone. The layer of silicone can cover the key 60, septum 72, and any additional adjacent features (e.g., tape joints). The layer of silicone can prevent movement of the septum 72 and/or plug, which may otherwise cause variation or change in the pressure of the between-pane space. This assists in retaining the insulative properties of the window unit.

In the example of FIGS. 6A-6D, septum 72 is illustrated as projecting above inner surface 96 of spacer key 60. In other examples, septum can be mounted flush with and/or recessed relative to inner surface 96 and/or outer surface 98 of spacer key 60. FIGS. 6E-6G are illustrations of an example portion of spacer key 60 utilizing a septum 72 that is mounted generally flush with inner surface 96 and outer surface 98 of spacer key 60. FIG. 6E is a perspective view of spacer key 60 according to the example. FIG. 6F is a bottom perspective view of spacer key 60 according to the example. FIG. 6G is a side sectional view of spacer key 60 according to the example.

In the example of FIGS. 6E-6G, septum 72 extends from a top end 109 to a bottom end 111. Top end 109 can define closed end 102 having a closed end face, while bottom end 111 can define open end 104. Wall 110 extending from top end 109 to bottom end 111 can form a tubular cavity 105 into which a piercing needle can be inserted. As shown in this example, top end 109 is substantially planar, and septum 72 can be mounted in spacer key 60 such that the top end is substantially coplanar with and/or recessed relative to inner surface 96 of the spacer key. As further shown in this example, bottom end 111 may be substantially planar, and septum 72 can be mounted in spacer key 60 such that the bottom end is substantially coplanar with and/or recessed relative to outer surface 98 of the spacer key. In some examples, a recessed pocket 113 is formed in the bottom spacer key 60 (e.g., with the recessed pocket being offset inwardly offset relative to outer surface 98). Recessed pocket 113 can be sized and shaped to receive bottom end 111 of septum 72 such that, when the septum is inserted into spacer key 60, the bottom surface is coplanar with and/or recessed relative to outer surface 98 of the spacer key.

When spacer key 60 is configured as described with respect to FIGS. 6A-6G, the septum 72 may be formed physically separate from spacer key 60 and inserted into port 100 of the spacer key, thereby forming a gas-tight seal between the septum 72 and the port 100. An adhesive or other sealing agent may optionally be used to seal between septum 72 and the port 100. In other configurations, septum 72 may be integrally formed with spacer key 60 to define a unitary structure where the septum is not separable from the spacer key without irreversibly damaging the spacer key. Configuring spacer key 60 with an integral septum can be useful, e.g., to reduce the width-wise size of spacer key needed to form a port for receiving a separate septum. This can be beneficial, e.g., when configuring spacer key 60 to be inserted into a comparatively small between-pane space, such as one having a pane-to-pane width less than 10.0 mm, less than 9.0 mm, less than 8.5 mm, less than 8.0 mm, less than 7.5 mm, less than 7.0 mm, less than 6.5 mm, less than 6.0 mm, less than 5.5 mm, less than 5.0 mm, or less than 4.5 mm.

FIGS. 6H-6K are illustrations of an example configuration of spacer key 60 in which septum 72 is defined by a thin wall of the same material from which the spacer key itself is constructed. FIG. 6H is a bottom perspective view of the example spacer. FIG. 6I is a top perspective view of the example spacer key. FIG. 6J is a prospective side sectional view of the example spacer key. FIG. 6K is a side sectional view of the example spacer key.

In the example of FIGS. 6H-6K, spacer key 60 is showing having a key length 82 extending from the first key end 88 to the second key end 90. Spacer key 60 can have first and second end portions having a cross-sectional size and/or shape substantially equivalent to tubular spacer 40, e.g., with first key end 88 size and shape indexed to fit inside first end 62 of the tubular spacer and a second key end 90 size and shape indexed to fit inside second end 64 of the spacer. Spacer key 60 can also have a key width 84 extending from one side of the key to an opposite side of the key, with key width falling within the range of any of the between-pane space sizes described herein.

Unlike other example implementations illustrated with septum 72 being separable from an inserted into a port of the spacer key, spacer key 60 in the example of FIGS. 6H-6K includes a wall 115, which can be formed of the same material from which a remainder of the spacer key is formed, that defines the septum. Wall 115 may be sufficiently thin so as to be penetrable with a needle to facilitate gas exchange. In various examples, wall 115 may have a thickness less than 10 mm, such as less than 5 mm, less than 2 mm, or less than 1 mm. The region of spacer key 60 defining wall 115 may include a downwardly extending wall surface 117 forming a cavity 119. Cavity 119 can have an open end accessible from the outer surface 98 of the spacer key into which a needle can be inserted. Wall 115 can bound and sealed closed the top end of cavity 119. In some examples, the region of wall surface 117 defining the open end of cavity 119 is tapered to help guide insertion of a penetrating needle into the cavity.

In use, wall 115 defining the septum portion of spacer key 60 can be pierced to allow the passage of a fluid therethrough. In some examples, piercing of the wall 115 can occur via needle penetration. The pierce can extend through wall 115. The pierce can be used to modify the pressure of the between-pane space, as discussed previously.

When configured as illustrated, spacer key 60 can be configured with a portion of material that has a reduced thickness compared to a remainder of the spacer key to facilitate penetration through the spacer key in the region of reduce material thickness. In some examples, an entirety of spacer key 60, including wall 115 that defines a penetrable location through the thickness of the spacer key for gas exchange, can be fabricated from a single material (e.g., a polymeric material during a molding process in which the entirety of the spacer key, including wall 115, is molded and formed as a unitary structure).

FIGS. 6L-6O are illustrations of another example configuration of spacer key 60. FIG. 6L is a bottom perspective view of the example spacer. FIG. 6M is a top perspective view of the example spacer key. FIG. 6N is a side sectional view of the example spacer key. FIG. 6O is an expanded side sectional view a portion of the example spacer key indicated by detail “C” in FIG. 6N.

Spacer key 60 in FIGS. 6L-6O is similar to the configuration of FIGS. 6H-6K however, instead of forming septum 72 with the same material from which the spacer key itself is constructed, the spacer key of FIGS. 6L-6O utilizes a separate material to form wall 115 than the rest of the material forming the spacer key. Like reference numbers in FIGS. 6L-6O refer to like features discussed above.

In the FIGS. 6L-6O, spacer key 60 includes port 100 defining an access opening from an exterior of the spacer key to an interior between-pane space sealed by the spacer key. Port 100 is sealed by one or more covering materials 121. In some examples, the one or more covering materials 121 are formed by overmolding a material used to form a remainder of the spacer key with the covering material. Overmolding is a manufacturing technique generally in which a second material is molded over an existing substrate or part to enhance its properties or functionality. This process can involve injecting a soft or flexible material, such as rubber or elastomer, over a rigid plastic component to create a multi-material part.

In the example of FIGS. 6L-6O, the body of spacer key 60 may be fabricated from a comparatively rigid material (e.g., rigid plastic like nylon) and/or metal (e.g., zinc plated steel, stainless steel, aluminum). Covering material may be a low durometer material that is comparatively softer than the rigid material forming a remained of the spacer key (e.g., a silicone-based and/or polyurethane-based material).

Covering material 121 can be molded over port 100, e.g., directly or over a support material 123 at least partially covering a cross-section of the port. In use, the spectrum defined by covering material can function as a septum that can be pierced to allow the passage of a fluid therethrough.

As noted above, a variety of different insulating glass unit systems, configurations, and techniques can be implemented to pressure adjust the gas pressure of a between-pane space to accommodate atmospheric pressure differences (between a manufacturing location and location of end use) according to the disclosure. In some examples, an insulating glass unit according to the disclosure can be manufactured to include one or more valves in fluid communication with one or more corresponding between-pane spaces of the insulating glass unit to pressure adjust the gas pressure in the between-pane space after initial manufacturing of the insulating glass unit. When so configured, the valve can open in response to a pressure differential between the gas pressure in the between-pane space and the ambient gas pressure of the surrounding environment. This can allow for pressure equalization between the between-pane space and the ambient gas pressure.

When insulating glass unit 10 is configured with one or more valves to allow for pressure adjustment between the between-pane space and ambient environment, the one or more valves may be positioned at a variety of locations along the insulating glass unit. In some examples, a valve is fluidly coupled to a spacer key (spacer key 60) used as a component forming a spacer such that the valve is install on the spacer as the spacer key is connected to the tubular spacer. Additionally or alternatively, the spacer key can include a port through which a valve can coupled after assembly of the spacer to the tubular spacer to form the resultant spacer.

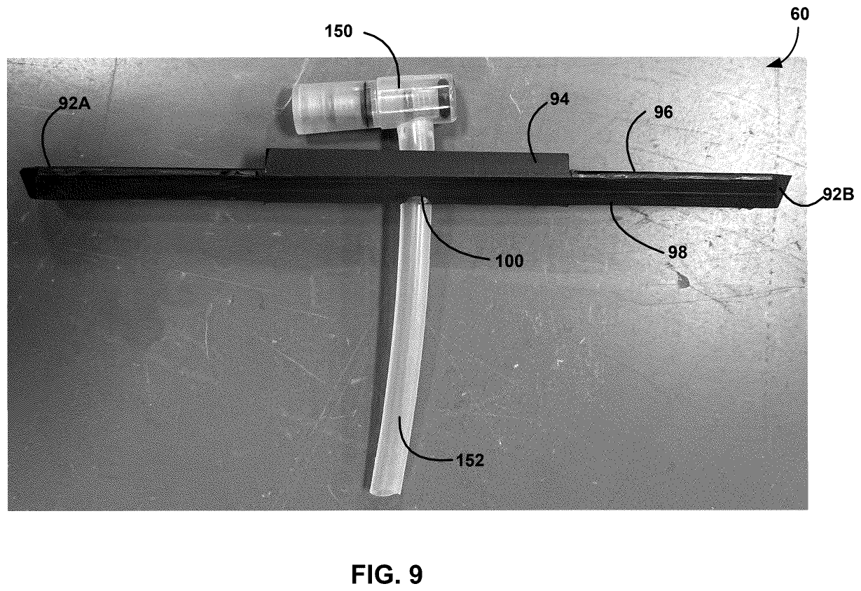

FIG. 9 is a perspective view of an example configuration of spacer key 60 that includes a valve 150 operable to control gas communication between the between-pane space of insulating glass unit 10 and an exterior environment. Spacer key 60 can be sized and configured as above with respect to configurations of the spacer key including septum 72. In the example of FIG. 9, however, spacer key 60 includes valve 150 in fluid communication through the thickness of the spacer key instead of septum 72.

For example, as discussed above, spacer key 60 in the example of FIG. 8 includes an inner surface 96 configured to face the between-pane space of the insulating glass unit and an outer surface 98 configured to face the external environment after being installed on tubular spacer 40. Spacer key 60 can define a first insertion portion 92A configured to be inserted into first end of tubular spacer 40, a second insertion portion 92B configured to be inserted into the second end of tubular spacer 40, and an intermediate region or portion 94 positioned between the first insertion portion and the second insertion portion. Valve 150 can be fluidly connected through intermediate region or portion 94 of spacer key 60 to control pressure between the between-pane space and surrounding environment.

Valve 150 can have a variety of different configurations. In one implementation, valve 150 is a two-way valve operable to discharge insulating gas from the between-pane space of insulating glass unit 10 when the ambient pressure is lower than the gas pressure in the between-pane space (e.g., lower than a threshold amount setting the cracking pressure of the valve) and also operable to allow ambient air to enter the between-pane space when the ambient pressure is greater than the gas pressure in the between-pane space (e.g., greater than a threshold amount setting the cracking pressure of the valve). In another example, valve 150 is a one-way valve operable to discharge insulating gas from the between-pane space of insulting glass unit 150 when the ambient pressure is lower than the gas pressure in the between-pane space (e.g., lower than a threshold amount setting the cracking pressure of the valve) but not operable to allow ambient air to enter the between-pane space when the ambient pressure is greater than the gas pressure in the between-pane space. In yet another example, valve 150 is a one-way valve operable to allow ambient air to enter the between-pane space of insulating glass unit 10 when the ambient pressure is greater than the gas pressure in the between-pane space (e.g., greater than a threshold amount setting the cracking pressure of the valve) but not operable to allow insulating gas to discharge from the between-pane space of insulting glass unit 150 when the ambient pressure is lower than the gas pressure in the between-pane space.

Valve 150 can have a variety of different configurations. In some examples, valve 150 includes a poppet or ball exposed to gas pressure from the between-pane space and/or surrounding environment. The poppet or ball may be retained against a valve seat by a spring. When the gas pressure exceeds the force of the spring acting on the ball or poppet, the gas unseats the ball or poppet, allowing an amount of gas to bypass the valve. The spring can re-seat the ball or poppet when enough gas has passed through the valve to drop the pressure differential between the between-pane space and ambient environment below the setting of the valve spring. Additionally or alternatively, valve 150 may include a membrane that is movable (e.g., hingedly attached) in response to a differential pressure. The membrane may move off a membrane seat in response to a threshold pressure differential (allowing gas communication past the membrane) and return to the membrane seat in response to the pressure differential falling below the threshold (closing gas communication past the membrane).

Spacer key 60 in the example of FIG. 9 includes a port 100 extending through the thickness of the spacer key. Valve 150 is in fluid communication through port 100. In some examples, such as that illustrated in FIG. 8, valve 150 is configured to be positioned inside of the between-pane space of insulating glass unit 10. For example, valve 150 can be positioned in contact with inner surface 96 of spacer key 60. When so configured, an inlet and/or outlet of valve 150 can communicate with the ambient environment surrounding insulating glass unit 10 via port 100 of spacer key 60. A tube or other lumen 152 fluidly connected to a port of valve 150 can extend through port 100 of spacer key 60. In various configurations, valve 15 can be directly integrated into spacer key 60 (e.g., the components forming the valve partially or fully contained the body of the spacer key), inserted into a receiving opening of the spacer key, and/or positioned against the spacer key but not contained within the body of the spacer key.

In other examples, valve 150 is configured to be positioned outside of the between-pane space of insulating glass unit 10. For example, valve 150 can be positioned in contact with outer surface 98 of spacer key 60. When so configured, an inlet and/or outlet of valve 150 can communicate with the between-pane space of insulating glass unit 10 via port 100 of spacer key 60. Again, a tube or other lumen 152 fluidly connected to a port of valve 150 can extend through port 100 of spacer key 60.

During manufacture of insulating glass unit 10, one or more between-pane spaces of the insulating glass unit can be filled with insulating gas to define a gas fill pressure in the between-pane space. During this initial assembly, the between-pane space can be sealed with a spacer 22 including spacer key 60 to close the between-pane space from gas exchange with a surrounding environment. Spacer key 60 carrying valve 150 can be inserted into tubular spacer 40 to form spacer 22 during assembly. Alternatively, spacer key 60 with port 100 can be inserted into tubular spacer 40 to form spacer 22 and valve 150 subsequently connected through the port. In either case, the assembled insulating glass unit 10 can include spacer 22 with spacer key 60 and valve 150. The gas fill pressure in the between-pane space after this initial manufacturing of the insulating glass unit may be substantially equal to atmospheric pressure at the location of manufacture of the insulating glass unit.

After initially fabricating insulating glass unit 10 with the between-pane space filled with insulating glass at the gas fill pressure (e.g., corresponding to atmospheric pressure at the location manufacture), the insulating gas unit can be transported to a different location at a higher or lower elevation and corresponding different atmospheric pressure. Valve 150 can adjust the pressure in the between-pane space in response to changes in the atmosphere pressure surrounding the insulating glass unit.

For example, when insulating glass unit 10 is transported to a higher elevation location and valve 150 is a two-way valve or a one-way valve configured to discharge gas from the between-pane space, the valve 150 may automatically open in response to a pressure differential between the ambient environment and gas pressure in the between-pane space. When valve 150 opens, a portion of the gas inside of the between-pane space can discharge into the ambient environment, reducing the gas pressure in the between-pane space. The valve may remain open until the gas pressure in the between-pane space is substantially pressure equalized with the ambient pressure, at which point the valve may automatically close.

When insulating glass unit 10 is transported to a lower elevation location and valve 150 is a two-way valve or a one-way valve configured to allow air to enter the between-pane space, the valve 150 may automatically open in response to a pressure differential between the ambient environment and gas pressure in the between-pane space. When valve 150 opens, ambient air can enter the between-pane space through the valve, mixing with insulating gas in the between-pane space and increasing the gas pressure in the between-pane space. The valve may remain open until the gas pressure in the between-pane space is substantially pressure equalized with the ambient pressure, at which point the valve may automatically close.

When insulating glass unit 10 is configured with valve 150, the insulating glass unit 10 can be manufactured at any desired elevation and then transported to any other desired elevation, e.g., for end use where the insulating glass unit is installed in a building wall opening. Example elevations and pressures discussed above with respect to configurations utilizing a septum are similarly applicable to configurations utilizing a valve. Valve 150 may open as the insulating glass unit 10 is transported from the location of manufacture to a final delivery/use location (in addition to or instead of opening at the final delivery/use location) based on the amount of elevation change and corresponding pressure differential as the insulating glass unit 10 unit is transported along a delivery route.

After insulating glass unit 10 has reached a target elevation (e.g., a final delivery and/or use location) the insulating glass unit may be allowed to pressure equalize at that location for a period of time before valve 150 is permanently sealed. Permanently sealing valve 150 may prevent gas ingress or egress through the valve over the service life of insulating glass unit 10, e.g., in the event that the mechanical seal provided by valve 150 fails over the expected long service life of the unit. Valve 150 may be permanently sealed using any suitable sealing material or combinations of sealing materials, including the example sealing materials 114 discussed above with respect to FIG. 8. For example, a rigid plug may be inserted into port 100, tube 152, and/or a portion of valve 150 in selective fluid communication between the between-pane space and the ambient environment. Additionally or alternatively, a chemical sealing material 114 can be provided over and/or in any of the foregoing features to help form a barrier layer closing the valve.

Various different insulating glass unit systems, configurations, and techniques can be implemented according to the disclosure to pressure adjust the gas pressure of a between-pane space to accommodate atmospheric pressure differences (between a manufacturing location and location of end use). As another example according to the disclosure, insulating glass unit 10 can be configured with an opening that is temporarily sealed and can be unsealed to pressure adjust the between-pane space. The temporary seal can be opened one or more times (e.g., opened, resealed closed, opened a second time, etc.) as insulating glass unit 10 is transported and/or delivered from a manufacturing location having one atmospheric pressure to one or more subsequent locations at one or more corresponding elevations having different atmospheric pressures.

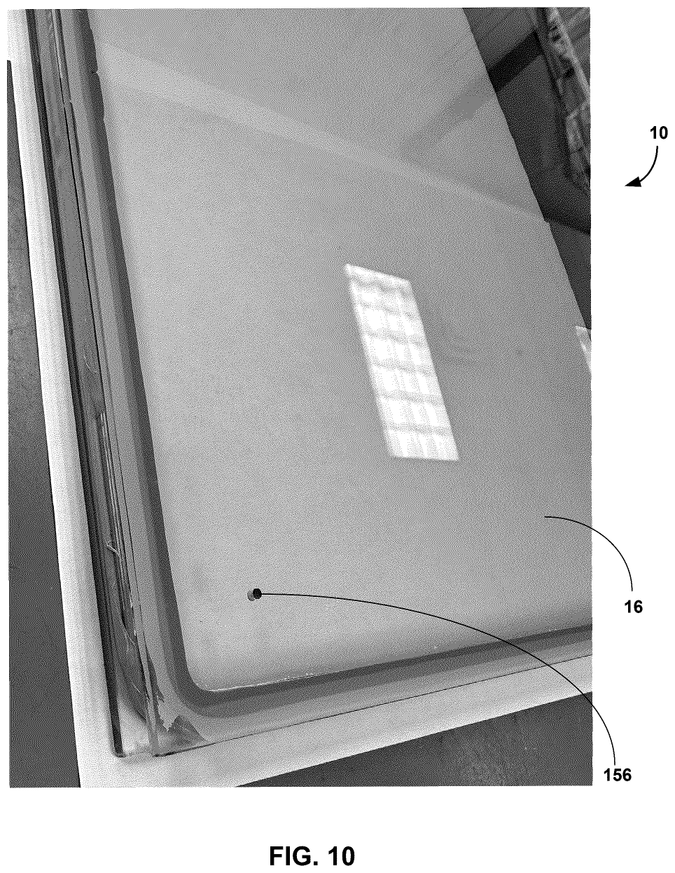

FIG. 10 is a perspective view of an example configuration of insulating glass unit 10 in which the insulating glass unit includes an opening 156 extending through the face of a first pane 16 of the unit. Opening 156 extend through the thickness of the material forming first pane 16, providing a pathway for fluid communication from the between-pane space defined by the insulating glass unit in the surrounding exterior environment. Opening 156 may be located at any suitable location along insulating glass unit 10 and, in some examples, is located near a peripheral edge of the insulating glass unit offset from the spacer extending around the perimeter of the unit. Opening 156 may have a size within a range from 0.5 mm to 10 mm, such as from 1 mm to 3 mm. Opening 156 can be formed using a laser and/or mechanical drill to penetrate through the face of first pane 16.

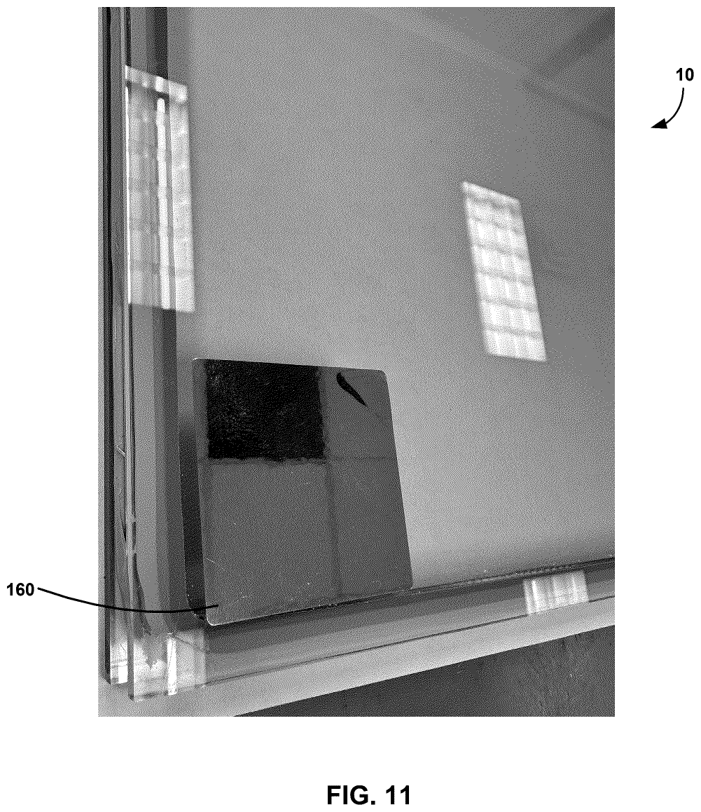

Opening 156 can be temporarily sealed with a temporary seal 160. FIG. 11 is a perspective view in insulating glass unit 10 illustrating of an example temporary seal 160 positioned over opening 156. Temporary seal 160 can be a plug, tape, film, and/or other removable sealant allowing the sealed to be opened by user and, optionally, resealed closed. In some example, temporary seal 160 may be sized larger than opening 156 in adhered to the extra face of first pane 16 about the entire perimeter of opening 156. Additionally or alternatively, temporary seal 160 may be insertable into opening 156 to close the opening through the thickness of first pane 16.

While the size and shape of temporary seal 160 can vary, in some examples, temporary seal 160 has a length and/or with within a range from 10 mm to 100 mm, such as from 30 mm to 70 mm. The sides of the temporary seal 160 can each be about the same length. In other examples, the sides of the temporary seal 160 can be different lengths.

Temporary seal 160 can be made of a variety of materials. The material of the temporary seal 160 can facilitate the removal and/or repositioning of the temporary seal 160. In some examples, the temporary seal 160 can be a low gas permeability material. The low permeability material can be a tape, such as a metallized mylar material. In some examples, the tape can be a high-strength acrylic double-sided tape. Temporary seal 160 may include or carry a pressure sensitive adhesive allowing the temporary seal to be adhesively secured to the face of first pane 16 over opening 156 to close gas communication through the opening.

Insulating glass unit 10 including opening 156 sealed by temporary seal 160 can be fabricated with a gas fill pressure substantially equal to the ambient pressure at the location of manufacture of the insulating glass unit. After fabrication, the insulating glass unit can be transported to a different elevation than the elevation at which the insulating glass unit is manufactured having a different ambient pressure than the ambient pressure at the location of manufacture. The temporary seal 160 can then be removed from the opening to allow the between-pane space to pressure adjust (e.g., equalize) with an ambient environment, e.g., by allowing insulating gas to discharge from the between-pane space through the opening or by allowing ambient air to enter through the opening into the between-pane space.

After the between-pane space has suitably pressure adjusted with the ambient environment, opening 156 can be sealed. Where the insulating glass unit is at a final use location and elevation, the opening may be permanently sealed for the service life of the insulating glass unit. Where the insulating glass unit is to be transported to yet a further location and elevation, opening 156 may be again temporarily sealed with the same or a different temporary seal 160 to allow further pressure equalization at one or more subsequent locations and elevations. In either case, once the insulating glass unit has been transported to a final delivery location and elevation (e.g., where the insulating glass unit is intended to be installed in a building), opening 156 providing access to the between-pane space may be permanently sealed for the service life of the insulating glass unit.

When insulating glass unit 10 is configured with opening 156, the insulating glass unit 10 can be manufactured at any desired elevation and then transported to any other desired elevation, e.g., for end use where the insulating glass unit is installed in a building wall opening. Example elevations and pressures discussed above with respect to configurations utilizing a septum and/or valve are similarly applicable to configurations utilizing opening 156 and seal 160.

After insulating glass unit 10 has reached a target elevation (e.g., a final delivery and/or use location) the insulating glass unit may be allowed to pressure equalize at that location for a period of time. Temporary seal 160 may be entirely removed from insulating glass unit 10 or may be peeled back to expose opening 156, allowing ingress of ambient air or egress of insulative gas through the opening.

After reaching a final delivery and/or use elevation and location, opening 156 may be permanently sealed using any suitable sealing material or combinations of sealing materials, including the example sealing materials 114 discussed above with respect to FIG. 8. For example, a rigid plug may be inserted into opening 156. Additionally or alternatively, a chemical sealing material 114 can be provided over and/or in opening 156 to help form a barrier layer closing the valve.

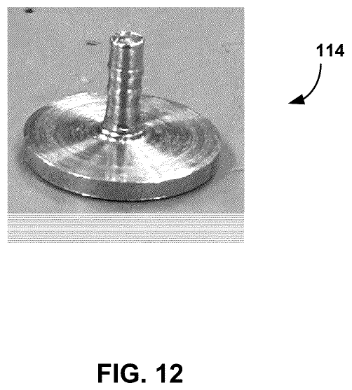

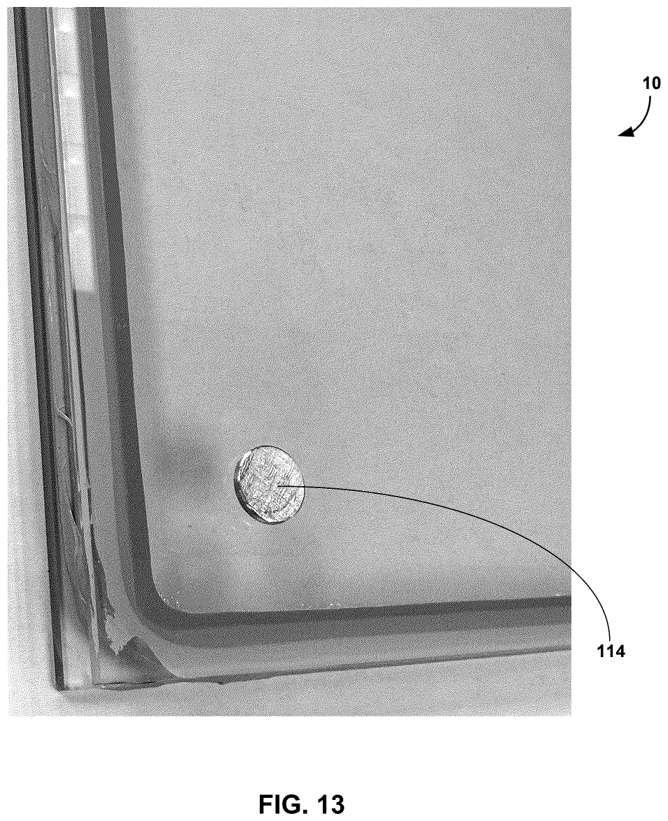

FIG. 12 illustrates an example plug 114 that can be used as a permanent seal. Plug 114 in this example includes a shaft insertable into opening 156 (to form a mechanical seal therewith) and a flange configured to be pressed against the exterior face of first pane 16. The plug can be made of a variety of materials. Some examples of the plug is made of metal, such as brass, stainless steel, or any suitable metal. In other examples, the plug is made of plastic, such nylon or any suitable plastic. In some examples, plug 114 is adhered to the first pane 16 using an adhesive. In some examples, the adhesive can be a tape placed over the plug and/or carried by the head of the plug (such that the adhesive tape contacts and adheres to the face of first pane 16 when the shaft of the plug is inserted into opening 156). The tape can be a high-strength acrylic double-sided tape or other suitable barrier material. The tape can be die-cut to accommodate the structure of the plug (e.g., such as matching and extending beyond the perimeter edge of the head of the plug). In other examples, the adhesive may be a liquid adhesive, such as an epoxy, place over plug 114 after insertion into opening 156. FIG. 13 is a perspective view of insulating glass unit 10 showing plug 114 inserted into opening 156.

Insulating glass unit systems, configurations, and techniques described herein can be implemented in a variety of different ways to pressure adjust the gas pressure of a between-pane space to accommodate atmospheric pressure differences (between a manufacturing location and location of end use) according to the disclosure. For instance, in some examples, an insulating glass unit according to the disclosure is manufactured to include one or more valves in fluid communication with one or more corresponding between-pane spaces of the insulating glass unit to pressure adjust the gas pressure in the between-pane space after initial manufacturing of the insulating glass unit. The valve can open in response to a pressure differential between the gas pressure in the between-pane space and the ambient gas pressure of the surrounding environment to allow for pressure equalization between the between-pane space and the ambient gas pressure. After allowing the between-pane space to suitably pressure equalize (e.g., transporting the insulating glass unit to an elevation of intended use and/or sale), the valve may be removed and opening in the insulating glass unit to which the valve was previously connected sealed closed for the service life of the unit.

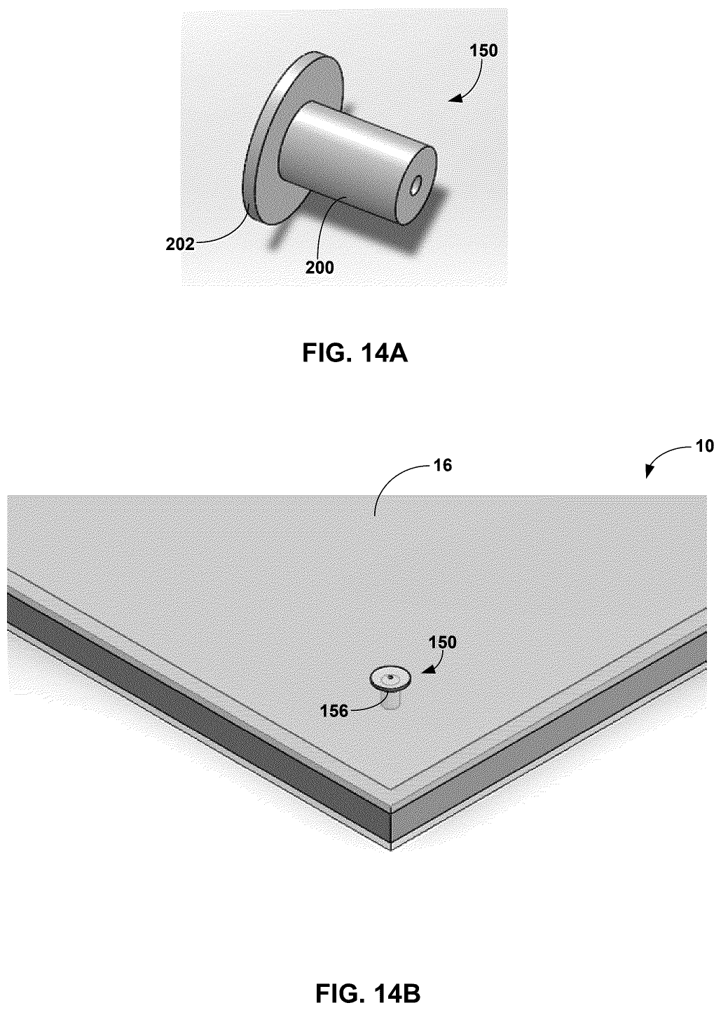

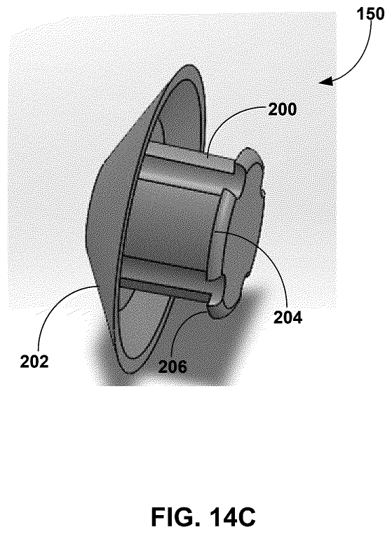

FIG. 14A is a perspective view of an example valve 150 that can be used with insulating glass unit 10 as described herein. FIG. 14B is a perspective view of a portion of insulating glass unit 10 illustrating the example valve 150 from FIG. 14A inserted into an opening 156 providing access to the between-pane space of the insulating glass unit. Opening can be positioned at a number of locations along insulating glass unit 10, such as extending through spacer 22 and/or spacer key 60. In the illustrated example of FIG. 14A, opening 156 is shown extending through the face of a first pane 16 of the unit. Opening 156 extend through the thickness of the material forming first pane 16, providing a pathway for fluid communication from the between-pane space defined by the insulating glass unit in the surrounding exterior environment. Opening 156 may be located at any suitable location along insulating glass unit 10 and, in some examples, is located near a peripheral edge of the insulating glass unit offset from the spacer extending around the perimeter of the unit.

Valve 150 can be fluidly connected to opening 156 and used to control gas communication through the opening. With reference to FIG. 14A, valve 150 may be configured with a stem 200 that defines a lengthwise extent of the valve and a head 202. Stem 200 of valve may be inserted into opening 156, with head 202 sized larger than the opening. Stem 200 may be at least partially inserted into the opening, e.g., until head 202 is positioned adjacent to and/or in contact with the exterior face of first pane 16.

Valve 150 may be temporarily affixed to and/or sealed to or in opening 156. In some examples, valve is mechanically attached to first pane 16. For example, stem 200 of valve 150 may be sized relative to opening 156 to provide a friction fit between the stem and opening, thereby retaining the valve in the opening. In some examples, valve 150 may include a bushing extending outwardly from stem 200 that can be positioned under first pane 16 to help retain the valve in the opening. For example, FIG. 14C is a perspective view of an example configuration of valve 150 where the valve includes a bushing 204 at the end of the portion of stem 200 insertable into opening 156. Bushing 156 can define a lip 156 that can be positioned under and/or in contact with a face of first pane 16 (opposite the face of the pane against which head 202 is positioned).

In addition to or in lieu of mechanically attaching valve 150 to opening 156, valve 150 may be removably attached to the face of first pane 16 with an adhesive. For example, an adhesive can be positioned between the underside of head 202 and the face of first pane 16 (e.g., partially or fully surrounding opening 156) to adhesively bond the valve in the opening. The adhesive may be selected to allow an adhesive bond between the valve and first pane 16 to be broken by a user removing valve 150 from opening 156 (e.g., allowing the valve to be removed from the opening under normal human hand force without breaking the valve). In some examples, the adhesive used to adhere the valve to first pane 16 (in the opening) is a stretch releasing adhesive that releases (breaking the adhesive bond) in response to a pulling stretch force. For example, the stretch adhesive may include a pull tab configured to be grasp to stretch and release the adhesive. Example stretch release adhesive configurations are described in U.S. Pat. No. 6,541,089, titled “Stretch releasing adhesive tape with integral pull tab” and U.S. Pat. No. 10,927,277, titled “Adhesive articles permitting damage free removal,” the entire contents of which are incorporated herein by reference.

Valve 150 can have a variety of different configurations as discussed above with respect to FIG. 9. In one implementation, valve 150 is a two-way valve operable to discharge insulating gas from the between-pane space of insulating glass unit 10 when the ambient pressure is lower than the gas pressure in the between-pane space (e.g., lower than a threshold amount setting the cracking pressure of the valve) and also operable to allow ambient air to enter the between-pane space when the ambient pressure is greater than the gas pressure in the between-pane space (e.g., greater than a threshold amount setting the cracking pressure of the valve). In another example, valve 150 is a one-way valve operable to discharge insulating gas from the between-pane space of insulting glass unit 150 when the ambient pressure is lower than the gas pressure in the between-pane space (e.g., lower than a threshold amount setting the cracking pressure of the valve) but not operable to allow ambient air to enter the between-pane space when the ambient pressure is greater than the gas pressure in the between-pane space. In yet another example, valve 150 is a one-way valve operable to allow ambient air to enter the between-pane space of insulating glass unit 10 when the ambient pressure is greater than the gas pressure in the between-pane space (e.g., greater than a threshold amount setting the cracking pressure of the valve) but not operable to allow insulating gas to discharge from the between-pane space of insulting glass unit 150 when the ambient pressure is lower than the gas pressure in the between-pane space.

During manufacture of insulating glass unit 10, one or more between-pane spaces of the insulating glass unit can be filled with insulating gas to define a gas fill pressure in the between-pane space. Open or more openings 156 can be formed providing access between the between-pane space and an ambient environment. Valve 150 can be connected to the one or more openings, e.g., by inserting stem 200 into the opening and adhesively bonding valve head 202 to the face of first pane 16. Typically, opening 156 may be formed and valve 150 attached before assembling insulating glass unit 10 and/or gas-filling the between pane space. In either case, valve 150 can control fluid communication between the gas-filled between-pane space and ambient environment.

After initially fabricating insulating glass unit 10 with the between-pane space filled with insulating glass at the gas fill pressure (e.g., corresponding to atmospheric pressure at the location manufacture), the insulating gas unit can be transported to a different location at a higher or lower elevation and corresponding different atmospheric pressure. Valve 150 can adjust the pressure in the between-pane space in response to changes in the atmosphere pressure surrounding the insulating glass unit.

For example, when insulating glass unit 10 is transported to a higher elevation location and valve 150 is a two-way valve or a one-way valve configured to discharge gas from the between-pane space, the valve 150 may automatically open in response to a pressure differential between the ambient environment and gas pressure in the between-pane space. When valve 150 opens, a portion of the gas inside of the between-pane space can discharge into the ambient environment, reducing the gas pressure in the between-pane space. The valve may remain open until the gas pressure in the between-pane space is substantially pressure equalized with the ambient pressure, at which point the valve may automatically close.

When insulating glass unit 10 is transported to a lower elevation location and valve 150 is a two-way valve or a one-way valve configured to allow air to enter the between-pane space, the valve 150 may automatically open in response to a pressure differential between the ambient environment and gas pressure in the between-pane space. When valve 150 opens, ambient air can enter the between-pane space through the valve, mixing with insulating gas in the between-pane space and increasing the gas pressure in the between-pane space. The valve may remain open until the gas pressure in the between-pane space is substantially pressure equalized with the ambient pressure, at which point the valve may automatically close.

When insulating glass unit 10 is configured with valve 150, the insulating glass unit 10 can be manufactured at any desired elevation and then transported to any other desired elevation, e.g., for end use where the insulating glass unit is installed in a building wall opening. Example elevations and pressures discussed above with respect to configurations utilizing a septum are similarly applicable to configurations utilizing a valve. Valve 150 may open as the insulating glass unit 10 is transported from the location of manufacture to a final delivery/use location (in addition to or instead of opening at the final delivery/use location) based on the amount of elevation change and corresponding pressure differential as the insulating glass unit 10 unit is transported along a delivery route.

After insulating glass unit 10 has reached a target elevation (e.g., a final delivery and/or use location) the insulating glass unit may be allowed to pressure equalize at that location for a period of time. Valve 150 can then be detached from insulating glass unit 10. For example, a user can break an adhesive bond between valve 150 and first pane 16 (e.g., by applying a pulling force to a stretch releasing adhesive). The user can remove valve 150 from opening 156 by pulling stem 200 out of the opening. In either case, the valve can be separated from insulating glass unit 10.

With valve 150 removed from opening 156 and insulating glass unit 10, the user can permanently seal opening 150. Permanently sealing opening 156 can prevent gas ingress or egress through the opening over the service life of insulating glass unit 10. Opening 156 may be permanently sealed using any suitable sealing material or combinations of sealing materials, including the example sealing materials 114 discussed above with respect to FIG. 8. For example, a rigid plug (e.g., as described with respect to FIGS. 12 and 13) may be inserted into opening 156 to seal gas communication between the between-pane space and the ambient environment. Additionally or alternatively, a chemical sealing material 114 can be provided over and/or in opening 156 (and/or a plug inserted therein) to help form a barrier layer closing the opening.

While valve 150 has generally been described in conjunction with FIGS. 14A-14C as being insertable into opening 156 to seal gas communication between the between-pane space and the ambient environment, the valve may alternative be positioned external to first pane of transparent material 16 of insulating glass unit 10 and fluidly connected to opening 156.

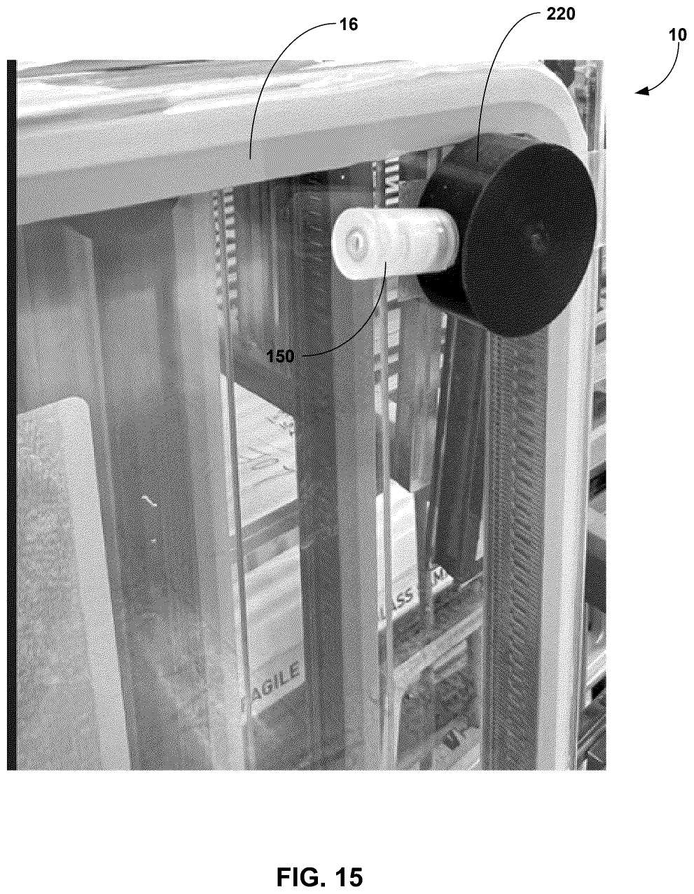

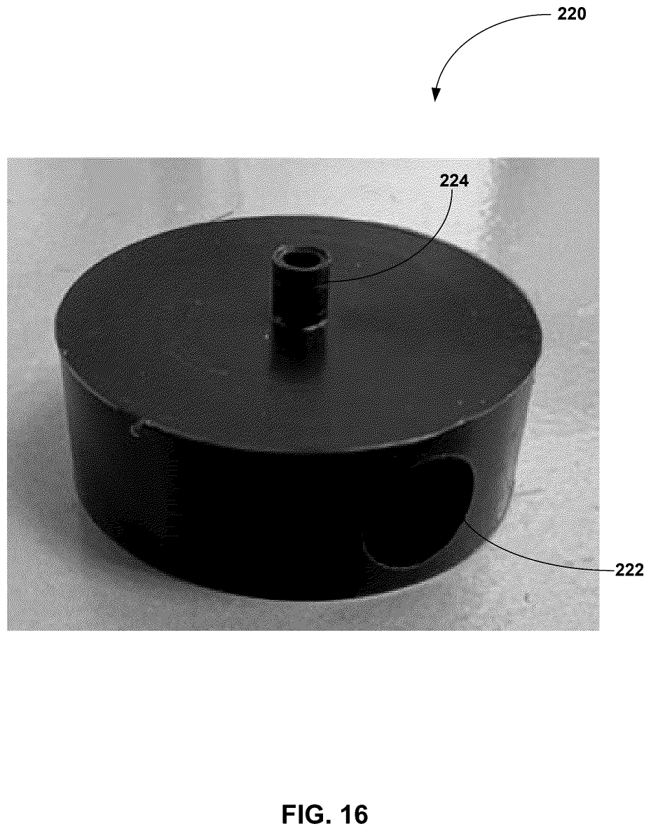

FIG. 15 is a perspective view of an example configuration of insulating glass unit 10 showing an example arrangement for fluidly coupling a valve 150 through an opening (e.g., opening 156) extending through a thickness of first pane of transparent material 16. In particular, FIG. 15 illustrates valve 150 fluidly connected through an opening extending through a thickness of the pane transparent material via a coupling 220. FIG. 16 is a perspective illustration of an example configuration of coupling 220. As shown, coupling 220 can have a port 222 configured to receive and/or fluidly couple with valve 150. Coupling 220 can also include a stem 224 configured (e.g., sized and shaped) to be inserted into opening 156. Once inserted, a fluid-tight seal can be formed between the perimeter of opening 156 and stem 224. A gasket or other sealing feature may be utilized to seal between opening 156 and stem 224. In either case, the resulting assembly can provide one or two-way gas control via valve 150 positioned outside of insulating glass unit 10. Once at a desired location, coupling 220 can be removed by pulling stem 224 out of opening 156 and the opening thereafter sealed, as described herein.

Insulating glass units and techniques for manufacturing insulating glass units have been described. In some examples, a manufacturing technique involves filling a between-pane space located between a first glass pane and a second glass pane of an insulating glass unit with an insulative gas to ambient pressure at the location where the insulating glass unit is manufactured. The insulating glass unit can include one or more features allowing the pressure of the insulative gas to be adjusted (increased and/or decreased) after initial fabrication of the insulating glass unit. For example, the insulating glass unit can include one or more features allowing the pressure of the insulating gas to be adjusted from ambient pressure at the location of manufacture to a different ambient pressure corresponding to an elevation where the insulating glass unit is intended to be used.

The described configurations can be utilized to accommodate atmospheric pressure changes occurring as a result of the natural, ambient pressure of the air surrounding the insulting glass unit and building in which the insulting glass unit is installed being different than the natural, ambient pressure of the air at the location of manufacture of the insulating glass unit (which may set the gas fill pressure inside the of the insulating glass unit). The foregoing description has referred to the insulting glass unit being transported to a final delivery and/or use location and, in some examples, pressure adjusted relative to that location. In practice, it should be appreciated that the delivery and/or use location may be a distribution center, sales location, or other facility at the same approximate elevation where the insulating glass unit is intended to be (or actually is) installed. Accordingly, reference to a final delivery and/or use location is not intended to exclude these applications or require pressure adjustment at the exact elevation of the building where the unit is installed or to the exact pressure at that location.

Various examples have been described. These and other examples are within the scope of the following claims.

1. A method comprising:
filling a between-pane space of an insulating glazing structure defined between a first pane of transparent material and a second pane of transparent material with an insulating gas to define a gas fill pressure in the between-pane space;
positioning a spacer between the first pane of transparent material and a second pane of transparent material so as to seal the between-pane space from gas exchange with a surrounding environment, wherein the spacer comprises a tubular body having a first end and a second end joined together by a key, and the key comprises a septum;
piercing the septum and adjusting a pressure of the insulating gas in the between-pane space through a pierce in the septum so that the pressure in the between-pane space is different than the fill pressure; and
sealing the pierce through the septum with a sealing material.

2. The method of claim 1, wherein the gas fill pressure is substantially equal to atmospheric pressure at the location of manufacture of the insulating glazing structure.

3. The method of claim 1, wherein adjusting the pressure of the insulating gas in the between-pane space comprises reducing the gas pressure in the between-pane space below the gas fill pressure.

4. The method of claim 3, wherein reducing the gas pressure in the between-pane space below the gas fill pressure comprises causing the first pane of transparent material and the second pane of transparent material to bow inwardly toward each other.

5. The method of claim 3, wherein reducing the gas pressure in the between-pane space below the gas fill pressure comprises reducing the gas pressure from 1 pounds per square inch (psi) to 7 psi less than the gas fill pressure.

6. The method of claim 1, wherein adjusting the pressure of the insulating gas in the between-pane space comprises increasing the gas pressure in the between-pane space above the gas fill pressure.

7. The method of claim 1, wherein adjusting the pressure of the insulating gas in the between-pane space comprises adjusting the pressure to be substantially equal to an atmospheric pressure at a target elevation of use for the insulating glazing structure.

8. The method of claim 7, wherein the target elevation is at least 1000 feet different than an elevation at a location of manufacture of the insulating glazing structure.

9. The method of claim 7, further comprising transporting the insulating glazing structure to the target elevation and/or installing the insulating glazing structure in a building at the target elevation.

10. The method of claim 1, wherein:
the key has an inner surface facing the between-pane space, an outer surface facing the external environment, and a port; and
the septum is inserted into the port, and a gas-tight seal is formed between the septum and the port.

11. The method of claim 10, wherein the septum comprises a tubular body with a radially extending flange on one end of the tubular body, and the tubular body is inserted into the port with the flange abutting the outer surface of the key.

12. The method of claim 1, wherein:
the key has a length extending from a first key end to a second key end;
the key defines a first insertion portion configured to be inserted into the first end of the tubular body, a second insertion portion configured to be inserted into the second end of the tubular body, and an intermediate region positioned between the first insertion portion and the second insertion portion; and
the septum is located in the intermediate portion of the key.

13. The method of claim 1, wherein the septum is defined by a wall of material that is integrally formed with a remainder of the spacer key, and piercing the septum comprises piercing the wall.

14. The method of claim 1, wherein the septum is defined by an overmolded layer of material, and piercing the septum comprises piercing the overmolded layer.

15. The method of claim 1, wherein piercing the septum comprises piercing the septum with a needle in fluid communication with a gas line.

16. The method of claim 15, wherein the gas line is in fluid communication with either (a) a gas source configured to introduce the insulating gas into the between-pane space or (b) a vacuum source configured to withdraw the insulating gas from the between-pane space.

17. The method of claim 1, wherein sealing the pierce through the septum with the sealing material comprises inserting a plug into a cavity defined by the septum.

18. The method of claim 1, wherein sealing the pierce through the septum with the sealing material comprises applying a sealing layer over the pierce.

19. The method of claim 1, wherein:
the insulating gas comprises at least one of argon, xenon, and krypton; and
the first pane of transparent material and the second pane of transparent material each comprise float glass.

20. An insulating glazing structure comprising:
a first pane of transparent material;
a second pane of transparent material; and
a spacer positioned between the first pane of transparent material and the second pane of transparent material to define a between-pane space, the spacer sealing the between-pane space from gas exchange with a surrounding environment and holding the first pane of transparent material a separation distance from the second pane of transparent material;
wherein the spacer comprises a tubular body having a first end and a second end joined together by a key, the key has a first key end and a second key end that are inserted into the first end and the second end of the tubular body, respectively;
the key comprises a septum positioned between the first end and the second end of the tubular body, and the septum is pierced and sealed closed with a sealing material; and
the between-pane space is filled with an insulating gas.

21. The structure of claim 20, wherein the between-pane space is filled with the insulating gas and has a pressure different than an atmospheric pressure at a location of manufacture of the insulating glazing structure.

22. The structure of claim 21, wherein the pressure different than the atmospheric pressure at the location of manufacture is a pressure less than the atmospheric pressure at the location of manufacture.

23. The structure of claim 20, wherein:
the key has an inner surface facing the between-pane space, an outer surface facing the external environment, and a port; and
the septum is inserted into the port, and a gas-tight seal is formed between the septum and the port.

24. The structure of claim 20, wherein:
the key has a length extending from the first key end to the second key end;
the key defines a first insertion portion configured to be inserted into the first end of the tubular body, a second insertion portion configured to be inserted into the second end of the tubular body, and an intermediate portion positioned between the first insertion portion and the second insertion portion; and
the septum is located in the intermediate portion of the key.

25. The structure of claim 20, wherein the key has a length extending from the first key end to the second key end, the first end is tapered relative to an intermediate portion and the second end is tapered relative to the intermediate portion to provide a first tapered region and a second tapered region, and the first tapered region is press fit into the first end of the tubular body and the second tapered region is press fit into the second end of the tubular body.
